(19) United States
(12) Patent Application Publication
(10) Pub. No.: US 2026/0314632 A1
(43) Pub. Date: Oct. 15, 2026

(54) METHOD OF PRODUCING A MODIFIED PROTEIN COMPOSITION BY REACTION WITH OXIDIZED PHENOLIC COMPOUNDS, THE MODIFIED PROTEIN COMPOSITION, AND NUTRITIONAL USES OF THE MODIFIED PROTEIN COMPOSITION

(71) Applicant: ARLA FOODS AMBA, Viby J (DK)

(72) Inventors: Søren Bang NIELSEN, Viby J (DK); Peter Aasted PAULSEN, Viby J (DK); Camilla Bertel ANDERSEN, Viby J (DK)

(21) Appl. No.: 19/474,052

(22) PCT Filed: Apr. 19, 2024
(86) PCT No.: PCT/EP2024/060797

§ 371 Date: Oct. 9, 2025

(30) Foreign Application Priority Data
Apr. 19, 2023 (EP) 23168798.9

(51) Int. Cl. A23J 1/20; A23B 70/30; A23J 3/08; A23L 2/66

(52) U.S. Cl. CPC A23J 1/205; A23B 70/30; A23J 3/08; A23L 2/66

(57) ABSTRACT

The present invention pertains to a method of preparing modified protein compositions under conditions that expose and modify free thiol groups of beta-lactoglobulin through reaction with oxidized phenolic compounds. The resulting modified protein product has been found to have an excellent performance in e.g. protein-rich beverage products and has particularly been found to give rise to a reduced level of unpleasant odours during sterilizing heat-treatments at neutral pH and during consumption of such beverage products.

### FIELD OF THE INVENTION

The present invention pertains to a method of preparing modified protein compositions under conditions that expose and modify free thiol groups of beta-lactoglobulin through reaction with oxidized phenolic compounds. The resulting modified protein product has been found to have an excellent performance in e.g. protein-rich beverage products and has particularly been found to give rise to a reduced level of unpleasant odours during sterilizing heat-treatments at neutral pH and during consumption of such beverage products.

### BACKGROUND

pH-neutral, whey protein-rich beverages have a tendency to produce an unpleasant odour similar to the odour of rotten eggs during thermal processing. The beverages are typically bottled immediately after production and therefore expose the consumer to the unpleasant odour when the bottle is opened.

WO 2021/198968 A1 discloses a method of making a beverage comprising milk protein concentrate (MPC). The MPC is treated to allow for heat homogenisation of a beverage containing the MPC, while reducing occurrence of unpleasant odour (malodour and/or egg-type or sulfur-type small and/or taste). Specifically, the MPC comprises at least one whey protein, wherein 50-100% of the whey protein are denatured and wherein the calcium content has been depleted by about 5-20 percent by weight.

Li et al (“Cysteine residues are responsible for the sulfurous off-flavor formed in heated whey protein solutions”, Food Chemistry: Molecular Sciences, vol. 5, 1 Dec. 2022 (2022 Dec. 1), page 100120) discloses how the protein composition of a whey protein solution affects the release of H2S during heat-treatment of the solution.

Poojary et al (“Green Tea Extract Decreases Age-Derived Advanced Glycation Endproducts but Not Lys-Derived AGEs in UHT Milk during 1-Year Storage”, Journal of Agricultural and Food Chemistry, vol. 68, no. 48, 17 Nov. 2020D2) studies the impact of adding green tea extracts to skim milk prior to UHT treatment and investigates the formation of advanced glycation products during long term storage.

Waqar et al (“Covalent bonding of 4-methylcatechol to beta-lactoglobulin results in the release of cysteine-4-methylcatechol adducts after in vitro digestion”, FOOD CHEMISTRY, vol. 397, 1 Dec. 2022 (2022 Dec. 1), page 133775) discloses the preparation and characterization of conjugates of 4-methylbenzoquinone and beta-lactoglobulin. Waqar does not contain any disclosures suggesting a reduced development of unpleasant odours due to chemical modification of beta-lactoglobulin.

### SUMMARY OF THE INVENTION

The inventors have noted that the unpleasant odour, which often accompanies pH-neutral, whey protein-rich beverages, is associated with hydrogen sulfide formed from free thiol groups of the cysteine-residues of the whey protein during thermal processing.

The inventors have furthermore discovered that this problem surprisingly can be reduced or even avoided by reacting beta-lactoglobulin-containing protein with oxidized phenolic compounds.

Thus, an aspect of the invention pertains to a method of producing a protein composition comprising modified beta-lactoglobulin (BLG), the method comprising the steps of
a) providing:
   a source comprising one or more phenolic compounds that contain at least two hydroxyl groups bound directly to the same aromatic ring (PCA), and
   a source comprising BLG,
b) optionally subjecting a portion of the source comprising one or more PCA to a type of oxidation capable of converting a PCA to a quinone thereby providing a source comprising one or more oxidized PCA (PCA-type oxidation),
c) combining a portion of the source comprising one or more PCA and/or a portion of the source comprising one or more oxidized PCA with a source comprising BLG and optionally with further ingredients to provide a protein solution, said protein solution having:
   a pH in the range of 6.5-9.5, and
   a BLG content of at least 0.2% w/w,
   a mole ratio between:
      the original amount of PCA used for preparing the protein solution, and
      the content of BLG of the protein solution, of at least 0.1:1,
d) incubating the protein solution within a temperature range and for a duration sufficient to reduce the amount of free thiol groups of the protein solution to at most 10 micromol/g protein, with the proviso that if the method does not contain step b), step d) also involves application of a type of oxidation capable of converting a PCA to a quinone,
preferably, wherein the PCA-type oxidation applied during step b) and/or step d) is sufficient to create a mole ratio between:
   the theoretical amount of quinone provided to the protein solution during the method determined according to Analysis 1, and
   the content of BLG of the protein solution
of at least 0.1:1.

Another aspect of the invention pertains to a protein composition comprising modified BLG, said protein composition is obtainable by the method of the present invention.

A further aspect of the invention pertains to a process for producing a heat-treated, preferably heat-sterilized, beverage, the process comprising the following steps:
1) mixing the protein composition of the present invention with one or more further beverage ingredients to obtain a liquid mixture having a pH of 5.5-8.5, and
2) filling the liquid mixture into suitable containers,
the process furthermore comprising at least one heat-treatment step wherein the liquid mixture is heat-treated, and preferably heat-sterilized, prior to filling and/or after filling,
preferably wherein the liquid mixture comprises the protein composition in an amount sufficient to contribute with at least 0.5% w/w protein.

Yet an aspect of the invention pertains to a heat-treated, preferably heat-sterilized, beverage having a pH of 5.5-8.5, obtainable by the process of the present invention.

Another aspect of the invention pertains to a food ingredient comprising:
the solids of the protein composition of the present invention, and
one or more further ingredient(s), preferably selected from:
   a dairy ingredient, preferably a non-oxidized dairy ingredient,
   a plant-based ingredient,
   a non-dairy carbohydrate source,
   a flavouring agent, and/or
   a sweetener.

An even further aspect of the invention pertains to the use of a protein composition comprising modified BLG, preferably the protein composition according to the present invention, as a food ingredient, preferably for:
improving the odour, and/or
reducing the level of unpleasant odour similar to the odour of rotten eggs, and/or
reducing the development of H2S during production, and/or
reducing the content of H2S in the headspace of the container,
   of heat-sterilized, beverages having a pH in the range of 5.5-8.5, preferably having a whey protein content of at least 3% w/w, and preferably heat-sterilized using indirect heat-treatment.

### DETAILED DESCRIPTION

An aspect of the invention pertains to a method of producing a protein composition comprising modified BLG, the method comprising the steps of
a) providing:
   a source comprising one or more phenolic compounds that contain at least two hydroxyl groups bound directly to the same aromatic ring (PCA), and
   a source comprising BLG,
b) optionally subjecting a portion of the source comprising one or more PCA to a type of oxidation capable of converting a PCA to a quinone thereby providing a source comprising one or more oxidized PCA (referred to as PCA-type oxidation),
c) combining a portion of the source comprising one or more PCA and/or a portion of the source comprising one or more oxidized PCA with a source comprising BLG and optionally with further ingredients to provide a protein solution, said protein solution having:
   a pH in the range of 6.5-9.5, and
   a BLG content of at least 0.2% w/w,
   a mole ratio between:
      the original amount of PCA used for preparing the protein solution, and
      the content of BLG of the protein solution,
of at least 0.1:1,
d) incubating the protein solution within a temperature range and for a duration sufficient to reduce the amount of free thiol groups of the protein solution to at most 10 micromol/g protein, with the proviso that if the method does not contain step b), step d) also involves application of a type of oxidation capable of converting a PCA to a quinone,
preferably, wherein the PCA-type oxidation applied during step b) and/or step d) is sufficient to create a mole ratio between:
   the theoretical amount of quinone provided to the protein solution during the method determined according to Analysis 1, and
   the content of BLG of the protein solution
of at least 0.1:1.

In the context of the present invention, the term “beta-lactoglobulin” or BLG, pertains to BLG from mammal species, e.g. in native and/or glycosylated forms and includes the naturally occurring genetic variants. The term BLG also encompasses BLG produced by recombinant technology and/or precision fermentation e.g. based on genetically modified microorganisms or mammalian cells. The term “BLG” or “beta-lactoglobulin” as used herein excludes unfolded and aggregated BLG. The content of BLG is measured according to Analysis L of PCT appl.no. PCT/EP2022/078739.

In the context of the present invention, the term “phenolic compounds” has its normal meaning and refers to a molecular compound containing an aromatic ring of which at least one of the six carbon atom is directly bound to a hydroxyl group. The five other carbon atoms of aromatic ring may, individually, be bound to various groups including a hydroxyl group or a hydrogen. The phenolic compounds also comprise polyphenols.

In the context of the present invention, the term “phenolic compound comprising an aromatic ring to which at least two hydroxyl group are directly bound” (referred to as “PCA”) pertains to molecular compounds, such as e.g. catechol or epigallocatechinegallate (EGCG), containing an aromatic ring of which ring at least two carbon atoms are directly bound to a hydroxy group. The four other carbon atoms of the aromatic ring may, individually, be bound to various groups including a hydroxy group or a hydrogen.

A PCA preferably has the following structural formula:

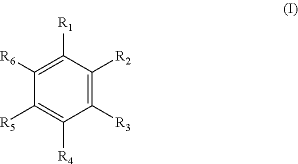

wherein at least two of R₁, R₂, R₃, R₄, R₅, and R₆ are hydroxyl groups.

Preferably two or three of R₁, R₂, R₃, R₄, R₅, and R₆ are hydroxyl groups.

In the context of the present invention, the term “a type of oxidation capable of converting a PCA to a quinone” or “PCA-type oxidation” pertains to an oxidative treatment capable of oxidizing PCA of the source comprising one or more PCA to a quinone. The PCA-type oxidation typically involves electrochemical oxidation and/or use of chemical oxidizing agents.

In the context of the present invention, the phrase “the PCA-type oxidation applied during step b) and/or step d) is sufficient to create a mole ratio[ . . . ]” is used to define the required level of PCA-type oxidation in a manner that can be applied to all embodiments of the method of the invention. In this context “step b) and/or step d)” means that if the method involves PCA-type oxidation during both a step b) and step d) then the combined PCA-type oxidation of both steps should be considered. However, if the method only involves PCA-type oxidation during step b) then only step b) should be considered. Similarly, if the method only involves PCA-type oxidation during step d) then only step d) should be considered.

As will be evident to the person skilled in the art, a mole ratio between component X and component Y which must be at least nx:ny means that the mole ratio must be at least nx divided by ny. nx and ny represent the amounts of components X and Y in mole. For example, if the mole ratio between component X and components Y must be at least 0.1:1 it means that nx divided by ny must be at least 0.1. The same logic applies to weight ratios.

In the context of the present invention, the phrase “theoretical amount of quinone provided to the protein solution during the method” is a measure of the mole content of quinones that is formed if all PCA (incl. PCA that have been converted to quinones) present in the protein solution of the method was oxidized under the same conditions and under the same oxidizing conditions used in the method but without the presence of proteins or other sources of free thiols or amines. The “theoretical amount of quinone provided to the protein solution during the method” is determined according to Analysis 1. For example, if the method of the invention is primarily based on oxidation of PCA during step b) (to provide a source comprising one or more oxidized PCA) prior to step c), then the content of quinones of the portion of the source comprising one or more oxidized PCA that is used for step c) is equal to the of the theoretical amount of quinone provided to the protein solution during the method.

In some preferred embodiments of the present invention the method of producing a protein composition comprising modified BLG furthermore comprises a step e) of drying a liquid feed comprising at least the protein derived from the incubated protein solution of step d).

In some preferred embodiments of the invention, the protein solution provided in step c) has a mole ratio between:
the original amount of PCA used for preparing the protein solution, and
the content of BLG of the protein solution,
   of at least 1:1,
   and the PCA-type oxidation applied during step b) and/or step d) preferably is sufficient to create a mole ratio between:
the theoretical amount of quinone provided to the protein solution during the method determined according to Analysis 1, and
the content of BLG of the protein solution
   of at least 1:1.

The term “source comprising one or more PCA” refers to the composition(s) used for providing the PCA for the protein solution of step c) and/or the oxidizing aqueous solution of step b). The term “the portion of the source comprising one or more PCA” pertains to the actual portion used for preparing the protein solution. In some preferred embodiments of the invention substantially all of the source comprising one or more PCA is used.

If more than one PCA-containing compositions are used for the production of the protein solution of step c) and/or the oxidizing aqueous solution of step b), then each of the used PCA-containing ingredients are considered sub-sources which make up the source comprising one or more PCA.

In some preferred embodiments of the present invention the PCA comprises a flavonoid, preferably a flavanol or a flavanol ester. Preferred flavonoids are e.g. catechin and a catechin derivative such as epicatechin, gallocatechin, epigallocatechin, catechin 3-gallate, epicatechin 3-gallate, gallo-catechin 3-gallate, and epigallocatechin 3-gallate (EGCG).

In other preferred embodiments of the present invention the PCA comprises a stilbenoid, preferably in the form of resveratrol.

The PCA preferably comprises caffeic acid, gallic acid, chlorogenic acid, catechol, 4-methyl catechol, catechin, epicatechin, gallocatechin, epigallocatechin, catechin 3-gallate, epicatechin 3-gallate, gallocatechin 3-gallate, epigallocatechin 3-gallate (EGCG), resveratrol, carnosic acid, carnosol, naringenin, or a mixture thereof.

In some preferred embodiments of the present invention one or more PCAs from the following group caffeic acid, gallic acid, chlorogenic acid, catechol, 4-methyl catechol, catechin, epicatechin, gallocatechin, epigallocatechin, catechin 3-gallate, epicatechin 3-gallate, gallocatechin 3-gallate, epigallocatechin 3-gallate (EGCG), resveratrol, carnosic acid, carnosol, naringenin contribute with at least 40 mol % of the PCAs of the source comprising one or more PCA, more preferably at least 50 mol %, even more preferably at least 60 mol %, even more preferably at least 70 mol %, even more preferably at least 80 mol % and most preferably at least 90 mol % of the PCAs of the source comprising one or more PCA.

In other preferred embodiments of the present invention one or more PCAs from the following group catechin, epicatechin, gallocatechin, epigallocatechin, catechin 3-gallate, epicatechin 3-gallate, gallocatechin 3-gallate, and epigallocatechin 3-gallate (EGCG) contribute with at least 40 mol % of the PCAs of the source comprising one or more PCA, more preferably at least 50 mol %, even more preferably at least 60 mol %, even more preferably at least 70 mol %, even more preferably at least 80 mol % and most preferably at least 90 mol % of the PCAs of the source comprising one or more PCA.

In further preferred embodiments of the present invention one or more PCAs from the following group caffeic acid, gallic acid, chlorogenic acid, catechol, 4-methyl catechol, catechin, epicatechin, gallocatechin, epigallocatechin, catechin 3-gallate, epicatechin 3-gallate, gallocatechin 3-gallate, epigallocatechin 3-gallate (EGCG), resveratrol, carnosic acid, carnosol, naringenin contribute with at least 40 mol % of the PCAs of the source comprising one or more PCA, more preferably at least 50 mol %, even more preferably at least 60 mol %, even more preferably at least 70 mol %, even more preferably at least 80 mol % and most preferably at least 90 mol % of the PCAs of the source comprising one or more PCA.

In even further preferred embodiments of the present invention one or more PCAs from the following group caffeic acid, gallic acid, and chlorogenic acid contribute with at least 40 mol % of the PCAs of the source comprising one or more PCA, more preferably at least 50 mol %, even more preferably at least 60 mol %, even more preferably at least 70 mol %, even more preferably at least 80 mol % and most preferably at least 90 mol % of the PCAs of the source comprising one or more PCA.

In other preferred embodiments of the present invention epigallocatechin 3-gallate (EGCG) contributes with at least 40 mol % of the PCAs of the source comprising one or more PCA, more preferably at least 50 mol %, even more preferably at least 60 mol %, even more preferably at least 70 mol %, even more preferably at least 80 mol % and most preferably at least 90 mol % of the PCAs of the source comprising one or more PCA.

In some preferred embodiments of the present invention the PCA have a molecular weight of at most 600 g/mol, more preferably most 400 g/mol, even more preferably most 350 g/mol, and more preferably most 310 g/mol.

In other preferred embodiments of the present invention the PCA have a molecular weight of at most 250 g/mol, more preferably at most 230 g/mol, even more preferably at most 210 g/mol, and more preferably at most 200 g/mol.

In some preferred embodiments of the present invention the PCA have a molecular weight in the range of 110-600 g/mol, more preferably 110-400 g/mol, even more preferably 110-350 g/mol, and more preferably 110-310 g/mol.

In some preferred embodiments of the present invention the PCA have a molecular weight in the range of 110-250 g/mol, more preferably 110-230 g/mol, even more preferably 120-210 g/mol, and more preferably 120-200 g/mol.

In other preferred embodiments of the present invention the PCA have a molecular weight in the range of 120-1000 g/mol, more preferably 250-700 g/mol, even more preferably 300-650 g/mol, and more preferably 350-600 g/mol.

In some preferred embodiments of the present invention the PCA neither contain nitrogen nor sulfur.

In some preferred embodiments of the present invention the PCA do not contain a carboxylic acid groups.

In some preferred embodiments of the present invention the PCA have a water solubility of at least 8 mM at 25 degrees C., more preferably at least 12 mM, and most preferably at least 16 mM.

In some preferred embodiments of the invention the source comprising one or more PCA is selected from a polyphenol extract from a herb, a polyphenol extract from a spice, polyphenol extract from a fruit, polyphenol extract from a berry, and mixtures thereof.

It is often preferred that the source comprising one or more PCA is preferably selected from the group consisting of a polyphenol extract of tea, more preferably a polyphenol extract of green tea; a polyphenol extract of coffee; polyphenol extract of cocoa; a polyphenol extract of grapes; a polyphenol extract of rosemary; a polyphenol extract of lemon balm; a polyphenol extract of black currant; a single PCA-isolate, and mixtures thereof.

“Polyphenol extracts” are well-known in the art and pertain to extracts targeting the polyphenol fraction of the given polyphenol source. In some preferred embodiments of the invention the polyphenol extract is a water-based extract. In other preferred embodiments of the invention the polyphenol extract is an extract based on water and ethanol.

In some preferred embodiments of the present invention the source comprising one or more PCA comprises PCA in an amount of at least 25% w/w relative to the total solids of the source comprising one or more PCA, more preferably at least 40% w/w, even more preferably at least 60% w/w, and most preferably at least 80% w/w relative to the total solids of the source comprising one or more PCA.

In further preferred embodiments of the present invention the source comprising one or more PCA is a single PCA-isolate comprising at single PCA in an amount of at least 25% w/w relative to the total solids of the source comprising one or more PCA, more preferably at least 40% w/w, even more preferably at least 60% w/w, and most preferably at least 80% w/w relative to the total solids of the source comprising one or more PCA.

It is preferred that the source comprising one or more PCA does not contribute with bitterness or off-taste to the protein composition comprising modified BLG.

The term “source comprising BLG” refers to the composition(s) used for providing BLG to the protein solution of step c).

If more than one BLG-containing composition are used for the production of the protein solution of step c) and/or the oxidizing aqueous solution of step b), then each of the used BLG-containing compositions are considered sub-sources which make up the source comprising BLG.

In some preferred embodiments of the present invention the protein of the source of BLG is isolated from mammal milk, and preferably from the milk of a ruminant such as e.g. cow, sheep, goat, buffalo, camel, llama, mare and/or deer. Protein isolated from bovine (cow) milk is particularly preferred. The BLG and the additional whey protein are therefore preferably bovine BLG and bovine whey protein. Alternatively, but also preferred, is protein prepared by fermentation of microorganisms during the production of recombinant BLG. If the BLG is recombinant BLG it is preferred that it has a sequence that resembles or even is identical to BLG from ruminant sources such as e.g. cow, sheep, goat, buffalo, camel, llama, mare and/or deer.

Preferably, the source comprising BLG comprises, or even consists of, a whey protein concentrate, a whey protein isolate, a milk serum protein concentration, a milk serum protein isolate, a BLG isolate, or a combination thereof.

The source of BLG may be in the form of a liquid or a powder, and its sub-sources may contain a combination of one or more powders comprising BLG and/or one or more liquids comprising BLG.

The term “whey” pertains to the liquid phase that is left after the casein of milk has been precipitated and removed. Casein precipitation may e.g. be accomplished by acidification of milk and/or by use of rennet enzyme. Several types of whey exist, such as “sweet whey”, which is the whey product produced by rennet-based precipitation of casein, and “acid whey” or “sour whey”, which is the whey product produced by acid-based precipitation of casein. Acid-based precipitation of casein may e.g. be accomplished by the addition of food acids or by means of bacterial cultures.

The term “milk serum” pertains to the liquid which remains when casein and milk fat globules have been removed from milk, e.g. by microfiltration or large pore ultrafiltration. Milk serum may also be referred to as “ideal whey”.

In the context of the present invention, the term “whey protein” pertains to the protein that is found in whey or milk serum. Whey protein may be a subset of the protein species found in whey or milk serum, and even a single whey protein species or it may be the complete set of protein species found in whey or/and in milk serum.

In some preferred embodiments of the invention the protein of the source comprising BLG is isolated from bovine whey or milk serum.

Unfractionated whey protein typically contains alpha-lactalbumin (ALA), beta-lactoglobulin (BLG), bovine serum albumin, immunoglobulins, osteopontin, lactoferrin, and lactoperoxidase.

Whey protein derived from rennet treated milk furthermore comprise caseinomacropeptide (CMP) in addition to the other protein species.

In the context of the present invention, the term “whey protein concentrate” (WPC) pertains to dry or aqueous compositions which contain a total amount of protein of 20-89% w/w relative to total solids.

A WPC preferably contains:
30-85% w/w protein relative to total solids,
15-90% w/w BLG relative to total protein,
4-50% w/w ALA relative to total protein, and
0-40% w/w CMP relative to protein.

Most preferably a WPC contains:
70-85% w/w protein relative to total solids,
30-90% w/w BLG relative to total protein,
4-35% w/w ALA relative to total protein, and
0-25% w/w CMP relative to protein.

WPC based on milk serum protein typically contains no CMP or only traces of CMP.

The term “whey protein isolate” (WPI) pertains to dry or aqueous compositions which contain a total amount of protein of 86-100% w/w relative to total solids.

A WPI preferably contains:
86-99% w/w protein relative to total solids,
30-100% w/w BLG relative to total protein,
0-35% w/w ALA relative to total protein, and
0-25% w/w CMP relative to total protein.

Most preferably a WPI contains:
90-99% w/w protein relative to total solids,
50-99% w/w BLG relative to total protein,
0-35% w/w ALA relative to total protein, and
0-25% w/w CMP relative to total protein.

WPI based on milk serum protein typically contains no CMP or only traces of CMP.

It is particularly preferred that the whey protein source is a WPI.

In the context of the present invention, the term “BLG isolate” pertains to a composition that contains BLG in an amount of at least 80% w/w relative to total solids, more preferably at least 90% w/w relative to total solids, and most preferably at least 95% w/w relative to total solids.

BLG isolates may e.g. be prepared by isolation of BLG from milk serum or whey, preferably according to WO2018115520 A1, or alternatively prepared recombinantly by fermentation of a genetically modified microorganisms or mammal cells.

The source comprising BLG preferably has a degree of protein denaturation of at most 30%, more preferably at most 25%, even more preferably at most 20% and most preferably as most 15%.

An even lower degree of protein denaturation is often preferred, and in some preferred embodiments of the present invention, the source comprising BLG has a degree of protein denaturation of at most 12%, more preferably at most 10%, even more preferably at most 8%, and most preferably at most 5%.

In some preferred embodiments of the invention the source comprising BLG has a total fat content of at most 10% w/w relative to total solids, more preferably at most 8% w/w, and most preferably at most 6% w/w relative to total solids.

In other preferred embodiments of the invention the source comprising BLG has a total fat content of at most 5% w/w relative to total solids, more preferably at most 2% w/w, even more preferably at most 0.5% w/w, and most preferably at most 0.1% w/w relative to total solids.

In further preferred embodiments of the invention the source comprising BLG has a total fat content in the range of 1-20% w/w relative to total solids, more preferably in the range of 2-16% w/w, even more preferably in the range of 3-12% w/w, and most preferably at most 4-10% w/w relative to total solids.

In some preferred embodiments of the present invention the source comprising BLG has a total carbohydrate content of at most 10% w/w relative to total solids, more preferably at most 8% w/w, even more preferably at most 6% w/w, and most preferably at most 5% w/w relative to total solids.

In further preferred embodiments of the present invention the source comprising BLG has a total carbohydrate content of at most 2% w/w relative to total solids, more preferably at most 1% w/w, even more preferably at most 0.5% w/w, and most preferably at most 0.2% w/w relative to total solids.

Step b) is optional in the sense that in some preferred embodiments of the present invention, the method comprises b) whereas other preferred embodiments of the present invention do not contain step b) and therefore do employ oxidation of a portion of the source comprising one or more PCA prior to step c).

Thus, in some preferred embodiments of the present invention the method of producing a protein composition comprising modified BLG comprises step b) of subjecting a portion of the source comprising one or more PCA to oxidation capable of converting a PCA to a quinone (also referred to as PCA-type oxidation) thereby providing a source comprising one or more oxidized PCA. It should be understood that the PCA-type oxidation must be able to oxidize the specific type of PCA specified in step a) to quinones.

Note that in some instances an oxidized PCA is not a PCA but only carries a quinone functionality.

In some preferred embodiments of the present invention the oxidation of step b) is involves preparing an oxidizing aqueous solution comprising the source comprising one or more PCA, optionally a chemical oxidizing agent and optionally one or more further ingredients such as water.

In the context of the present invention the term “oxidizing aqueous solution” is used to describe the aqueous solution in which the PCA-type oxidation of step b) takes place.

The oxidizing aqueous solution has a content of PCA of preferably at least 0.2 mM, more preferably at least 15 mM, and most preferably at least 50 mM.

In some preferred embodiments of the present invention the oxidizing aqueous solution has a concentration of PCA of 0.2-600 mM, more preferably 15-550 mM, and most preferably 50-500 mM.

For some PCA, it is advantageous if the oxidizing aqueous solution comprises one or more amphipathic modifiers to increase PCA solubility. The one or more amphipathic modifiers are preferably food-grade and/or pharmaceutical-grade amphipathic modifiers. Preferred examples of amphipathic modifiers are food grade alcohols, such as e.g. ethanol, dimethyl sulfoxide (DMSO), polysorbates, esters of sorbitan and fatty acids, and a mixture thereof.

Useful examples of polysorbates may e.g. be selected from the group consisting of polysorbate 20, 40, 60 and 80. Useful examples of esters of sorbitan and fatty acids may e.g. be selected from the group consisting of sorbitan monolaurate, sorbitan monostearate, sorbitan tristearate, and sorbitan monooleate.

In some preferred embodiments of the present invention the oxidizing aqueous solution has a pH in the range of 2-9.5, more preferably 6.5-9.5, even more preferably 7.1-9.0, even more preferably 7.3-8.7, and most preferably 7.4-8.5. pH-values mentioned herein refer to the pH normalized to 25 degrees C.

The inventors have found that it may be advantageous to perform step b) using an oxidizing aqueous solution having a pH in the range of 2-6.4, more preferably 3.0-6.0, even more preferably 3.5-5.5, and most preferably 4.0-5.0.

In some preferred embodiments of the present invention the oxidizing aqueous solution contains one or more further ingredients selected from the group consisting of a food acceptable acid, a food acceptable base, water, an amphipathic modifier, an chemical oxidizing agent, an oxidation catalyst, and a combination thereof.

Water is typically required as a further ingredient if the source comprising one or more PCA is provided in the form of a powder.

A chemical oxidizing agent is required in the oxidizing aqueous solution if the PCA-type oxidation of step b) should be partially or completely based on chemical oxidizing agent. It is even feasible to use a combination of several chemical oxidizing agents.

Food acceptable acids and/or food acceptable bases are typically required if the pH should be adjusted.

Useful examples of oxidation catalysts are one or more enzymes such as polyphenol oxidase, laccase and/or tyrosinase.

In some preferred embodiments of the present invention the oxidation of step b) is performed by contacting the portion of the source comprising one or more PCA with a chemical oxidizing agent under conditions that convert at least some of the PCA to quinones. This oxidation is performed in the oxidizing aqueous solution.

It is often preferred that the chemical oxidizing agent comprises, or even consists of, a peroxide, ozone, dioxygen, or a combination thereof.

In other preferred embodiments of the present invention the chemical oxidizing agent comprises, or even consists of, hydrogen peroxide, benzoyl peroxide, or a combination thereof.

In further preferred embodiments of the present invention the chemical oxidizing agent comprises, or even consists of, hydrogen peroxide, benzoyl peroxide, dioxygen, or a combination thereof.

In some preferred embodiments of the present invention the oxidation of step b) involves preparing an oxidizing aqueous solution comprising the portion of the source comprising one or more PCA, the chemical oxidizing agent and optionally one or more further ingredients such as water.

The PCA-type oxidation may also involve enzymatically catalysed oxidation, e.g., involving enzymes such as polyphenol oxidase, laccase and/or tyrosinase.

Dissolved dioxygen provided by the liquid(s) used to prepare the oxidizing aqueous solution used in step b) and/or the protein solution of step c) may contribute with trace oxidation of PCA but this is typically insufficient to achieve the desired level of oxidation required for the invention.

It is normally preferred that the oxidizing aqueous solution does not contain protein. Additionally it is preferred that the oxidizing aqueous solution does not contain molecules containing free thiol groups. In some preferred embodiments of the invention the oxidizing aqueous solution furthermore does not contain molecules having amine groups.

In some preferred embodiments of the invention the oxidizing aqueous solution contains less than 5% w/w protein relative to its weight, more preferably at most 1% w/w, even more preferably at most 0.1%; and most preferably no protein at all.

In some preferred embodiments of the invention the PCA-type oxidation of step b) involves electrochemical oxidation of the portion of the source comprising one or more PCA under conditions that convert at least some of the PCA to quinones.

In some preferred embodiments of the invention the oxidation of step b) involves preparing an oxidizing aqueous solution comprising the portion of the source comprising one or more PCA, and optionally one or more ingredients such as water.

Preferably, the electrochemical oxidation is operated using a potential difference of −0.1-1.5 V, more preferably 0.0-1.2 V, and most preferably 0.0 to 0.7V.

The potential difference, also referred to as the voltage, refers the potential difference between the working electrode(s) and counter electrode(s) that are used to perform the electrochemical oxidation of the PCA.

In some preferred embodiments of the invention the oxidizing aqueous solution has a pH in the range of 6-9 and the electrochemical oxidation is operated using a potential difference of −0.1 to 0.9, even more preferably 0-0.8 V, and most preferably 0.2-0.7 V.

In other preferred embodiments of the invention the oxidizing aqueous solution has a pH in the range of 3-5 and the electrochemical oxidation is performed using a potential difference of 0.1-1.3 V, and more preferably 0.2-0.9 V, and most preferably 0.3-0.7V.

For determining an appropriate potential difference to be used for electrochemical oxidation, it is advantageous to identify the oxidation potential of the PCA.

The required oxidation potential of the PCA may e.g. be determined by cyclic voltametry, wherein the electrode potential is swept from, e.g., −0.2 V to +1.2 V. At a given applied potential the current increases, as the PCA begins to oxidize at and/or near the working electrode surface. The current continues increasing as the potential is ramped up, until one or more peak currents are achieved, when the oxidizable groups of the PCA near the electrode are depleted.

The identified oxidation potential(s) at peak current(s) may be used in electrochemical oxidation of the PCA. If more than one peak is observed (such as the case for e.g. EGCG) the minimum applied potential difference giving rise to a peak current and results in formation of adequate amounts of quinones as determined by Analysis 2 is selected.

In some preferred embodiments of the invention, the electrochemical oxidation is implemented as bulk electrolysis and involves by holding the current at a constant potential while monitoring the decline in current over time as the PCA is oxidized to the quinone form. Preferably, the PCA is converted quantitatively into its quinone form. The current may reach a value of zero upon complete oxidation of PCA.

Agitation during bulk electrolysis is advantageous, e.g., in order to reduce diffusive limitations. Bulk electrolysis may be implemented using a potentiostat and a two electrode system or, preferably, a potentiostat and a three electrode system comprising one or more working electrodes, one or more counter electrodes, and a reference electrode.

The working electrode is preferably the anode. Preferred examples of a working electrode are a glassy carbon electrode, a boron doped diamond electrode, and a graphite electrode.

The counter electrode is preferably the cathode. A counter electrode is also known as auxiliary electrode. A preferred counter electrode is a platinum electrode, more preferably a platinum electrode selected from a coil type platinum electrode and a platinum flag electrode.

The reference electrode is preferably a true reference electrode or, more preferably, a quasi-reference electrode, which is also known as pseudo-reference electrode. A preferred example of a quasi-reference electrode is an Ag/AgCl electrode.

In some preferred embodiments of the invention, the electrochemical oxidation is performed under nitrogen.

The amount of quinones formed during electrochemical oxidation can be determined by Analysis 2. If analysis 2 is not available, the content of quinones can alternatively be determined using the GSH assay described in Example 2.

The PCA-type oxidation of step b) is partially or completely performed by electrochemical oxidation it is preferred that the oxidizing aqueous solution also comprises electrolytes. The oxidizing aqueous solution preferably comprises electrolytes in a concentration of 0.01-0.5 M; more preferably 0.05-0.4 M and most preferably 0.1-0.2 M. The used electrolytes are preferably food grade, conductive, and capable of contributing to a stable pH. In some preferred embodiments of the invention, the oxidizing aqueous solution comprises one of more electrolytes selected from the groups consisting of H2SO4, phosphoric acid, and acetic acid.

In some preferred embodiments of the invention, the electrochemical oxidation is performed at a temperature in the range of 2-80 degrees C., more preferably 5-60 degrees C., even more preferably 10-40 degrees C., and most preferably in the range of 15-30 degrees C.

In other preferred embodiments of the invention, the electrochemical oxidation is performed at a temperature in the range of 30-90 degrees C., more preferably 40-90 degrees C., even more preferably 50-90 degrees C., and most preferably in the range of 60-90 degrees C.

In further preferred embodiments of the invention, the electrochemical oxidation is performed at a temperature in the range of 5-25 degrees C., more preferably 10-25 degrees C., even more preferably 15-25 degrees C., and most preferably in the range of 18-25 degrees C.

The duration of step b) depends on the specific composition of oxidizing aqueous solution and the conditions used for the PCA-type oxidation. If electrochemical oxidation is used the current may be used to monitor the progress of the oxidation. When the current approaches zero at the operating potential difference it is a sign of depletion of PCA. The generated quinone content can be measured according to analysis 2.

In step c) of the method a portion of the source comprising one or more PCA and/or a portion of the source comprising one or more oxidized PCA are combined with a source comprising BLG and optionally with further ingredients to provide a protein solution having a pH in the range of 6.5-9.5.

In step c), the term “portion of the source comprising one or more oxidized PCA” pertains to the actual portion of the source comprising one or more oxidized PCA provided in step b) that is used for preparing the protein solution. In some preferred embodiments of the invention substantially all of the source comprising one or more oxidized PCA is used.

In step c), the term “portion of the source comprising one or more PCA” pertains to the actual portion of the source comprising one or more PCA of step a) that is used for preparing the protein solution. In some preferred embodiments of the invention substantially all of the source comprising one or more PCA is used.

In some preferred embodiments of the invention the protein solution has a pH in the range of 6.7-9.5, even more preferably 7.1-9.0, even more preferably 7.3-8.7, and most preferably 7.4-8.5.

The inventors have found that the pH ranges defined herein in relation to the protein solution favour selective modification of the free thiol group of BLG and reduce the risk of undesired reactions with the amine groups of BLG.

In some preferred embodiments of the invention the protein solution has a pH in the range of 6.5-9.5 and a temperature of at least 20 degrees C., more preferably at least 40 degrees C., even more preferably at least 60 degrees C. and most preferably at least 70 degrees C.

In further preferred embodiments of the invention the protein solution has a pH in the range of 7.1-9.0 and a temperature of at least 20 degrees C., more preferably at least 30 degrees C., even more preferably at least 50 degrees C. and most preferably at least 60 degrees C.

In particularly preferred embodiments of the invention the protein solution has a pH in the range of 7.3-8.7 and a temperature of at least 20 degrees C., more preferably at least 30 degrees C., even more preferably at least 50 degrees C. and most preferably at least 60 degrees C.

In even more preferred embodiments of the invention the protein solution has a pH in the range of 7.4-8.5 and a temperature of at least 35 degrees C., more preferably at least 40 degrees C., even more preferably at least 45 degrees C. and most preferably at least 50 degrees C.

Preferably, the protein solution has a pH in the range of 6.5-9.5 and a temperature of 20-70 degrees C., more preferably a pH in the range of 7.1-9.0 and a temperature of 20-60 degrees C., even more preferably a pH in the range of 7.3-8.7 and a temperature of 20-60 degrees C., and most preferably a pH in the range of 7.4-8.5 and a temperature of 35-50 degrees C.

In other preferred embodiments of the present invention the protein solution has a pH in the range of 6.5-9.5 and a temperature of 3-90 degrees C., more preferably a pH in the range of 7.1-9.0 and a temperature of 40-80 degrees C., even more preferably a pH in the range of 7.3-8.7 and a temperature of 45-75 degrees C., and most preferably a pH in the range of 7.4-8.5 and a temperature of 50-70 degrees C.

In further preferred embodiments of the present invention the protein solution has a pH in the range of 6.5-9.5 and a temperature of 5-90 degrees C., more preferably a pH in the range of 7.1-9.0 and a temperature of 8-80 degrees C., even more preferably a pH in the range of 7.3-8.7 and a temperature of 10-75 degrees C., and most preferably a pH in the range of 7.4-8.5 and a temperature of 15-70 degrees C.

In some preferred embodiments of the invention the protein solution has a BLG content of at least 0.5% w/w, more preferably at least 1% w/w, even more preferably at least 3% w/w, and most preferably at least 6% w/w.

In further preferred embodiments of the invention the protein solution has a BLG content of 0.5-30% w/w, more preferably 1-20% w/w, even more preferably 3-16% w/w, and most preferably 5-12% w/w.

In some preferred embodiments of the invention the protein solution has a BLG content of at least 30% w/w relative to total protein, more preferably at least 40% w/w relative to total protein, even more preferably at least 45% w/w relative to total protein, and most preferably at least 50% w/w relative to total protein.

In further preferred embodiments of the invention the protein solution has a BLG content of 30-99% w/w relative to total protein, more preferably 40-95% w/w relative to total protein, even more preferably 45-90% w/w relative to total protein, and most preferably 50-80% w/w relative to total protein.

In other preferred embodiments of the invention the protein solution has a BLG content of at least 60% w/w relative to total protein, more preferably at least 80% w/w relative to total protein, even more preferably at least 90% w/w relative to total protein, and most preferably at least 95% w/w relative to total protein

In some preferred embodiments of the invention the protein solution has a BLG content of at least 30% w/w relative to total solids, more preferably at least 40% w/w relative to total solids, even more preferably at least 45% w/w relative to total solids, and most preferably at least 50% w/w relative to total solids.

In further preferred embodiments of the invention the protein solution has a BLG content of 30-99% w/w relative to total solids, more preferably 40-95% w/w relative to total solids, even more preferably 45-90% w/w relative to total solids, and most preferably 50-80% w/w relative to total solids.

In alternative but also preferred embodiments of the invention the protein solution has a BLG content of at least 60% w/w relative to total solids, more preferably at least 80% w/w relative to total solids, even more preferably at least 90% w/w relative to total solids, and most preferably at least 95% w/w relative to total solids.

In some preferred embodiments of the invention the protein solution has a total fat content of at most 10% w/w relative to total solids, more preferably at most 8% w/w, and most preferably at most 6% w/w relative to total solids.

In other preferred embodiments of the invention the protein solution has a total fat content of at most 5% w/w relative to total solids, more preferably at most 2% w/w, even more preferably at most 0.5% w/w, and most preferably at most 0.1% w/w relative to total solids.

In further preferred embodiments of the invention the protein solution has a total fat content in the range of 1-20% w/w relative to total solids, more preferably in the range of 2-16% w/w, even more preferably in the range of 3-12% w/w, and most preferably 4-10% w/w relative to total solids.

The inventors have found that an advantage of the present invention is that it causes less fat oxidation than comparable methods for thiol modification. The method of the present invention is therefore suitable for gentle BLG modification in fat-rich systems.

In some preferred embodiments of the invention the protein solution has a total carbohydrate content of at most 10% w/w relative to total solids, more preferably at most 8% w/w, even more preferably at most 6% w/w, and most preferably at most 5% w/w relative to total solids.

In further preferred embodiments of the invention the protein solution has a total carbohydrate content of at most 2% w/w relative to total solids, more preferably at most 1% w/w, even more preferably at most 0.5% w/w, and most preferably at most 0.2% w/w relative to total solids.

In some preferred embodiments of the invention the protein solution has, and is therefore prepared to have, a mole ratio between:
the original amount of PCA used for preparing the protein solution, and
the content of BLG of the protein solution
   of at least 0.1:1, more preferably at least 0.2:1, even more preferably at least 0.3:1, and most preferably at least 0.4:1.

In other preferred embodiments of the invention the protein solution has, and is therefore prepared to have, a mole ratio between:
the original amount of PCA used for preparing the protein solution, and
the content of BLG of the protein solution
   of at least 1.5:1, more preferably at least 2:1, even more preferably at least 5:1, and most preferably at least 10:1.

In the context of the present invention the term “the original amount of PCA used for preparing the protein solution” pertains to the amount of the specific PCA mentioned in step a) used for preparing the portion of source comprising one or more PCA that is used for preparing the protein solution in step c) and/or the portion of the source comprising one or more oxidized PCA that is used for preparing the protein solution in step c).

If step c) only uses the a portion of the source comprising one or more oxidized PCA obtained from step b) then the “the original amount of PCA used for preparing the protein solution” pertains to the amount of PCA used for preparing that portion of source comprising one or more oxidized PCA.

If step c) only uses the a portion of the source comprising one or more PCA obtained from step a) then the “the original amount of PCA used for preparing the protein solution” pertains to the amount of PCA used for preparing that portion of source comprising one or more PCA.

If step c) both uses the a portion of the source comprising one or more PCA obtained from step a) and a portion of the source comprising one or more oxidized PCA obtained from step b) then the “the original amount of PCA used for preparing the protein solution” pertains to the amount of PCA used for preparing the portion of source comprising one or more PCA and the portion of source comprising one or more oxidized PCA.

The PCA referred to in steps b), c), d), and e) pertain to the PCA defined in step a).

In some preferred embodiments of the invention the protein solution has, and is prepared to have, a mole ratio between:
the original amount of PCA used for preparing the protein solution, and
the content of BLG of the protein solution
   of 0.1:1-1000:1, more preferably 0.2:1-500:1, even more preferably 0.3:1-200:1, and most preferably 0.4:1-100:1.

In further preferred embodiments of the invention the protein solution has, and is prepared to have, a mole ratio between:
the original amount of PCA used for preparing the protein solution, and
the content of BLG of the protein solution
   of 0.1:1-100:1, more preferably 0.1:1-50:1, even more preferably 0.1:1-20:1, and most preferably 0.1:1-10:1.

In even further preferred embodiments of the invention the protein solution has, and is prepared to have, a mole ratio between:
the original amount of PCA used for preparing the protein solution, and
the content of BLG of the protein solution
   of 0.1:1-6:1, more preferably 0.2:1-5:1, even more preferably 0.3:1-4:1, and most preferably 0.4:1-3:1.

In some preferred embodiments of the invention the protein solution has, and is prepared to have, a mole ratio between:
the original amount of PCA used for preparing the protein solution, and
the content of BLG of the protein solution
   of 1:1-1000:1, more preferably 2:1-500:1, even more preferably 5:1-200:1, and most preferably 10:1-100:1.

In further preferred embodiments of the invention the protein solution has, and is prepared to have, a mole ratio between:
the original amount of PCA used for preparing the protein solution, and
the content of BLG of the protein solution
   of 1:1-100:1, more preferably 1:1-50:1, even more preferably 1:1-20:1, and most preferably 1:1-10:1.

In even further preferred embodiments of the invention the protein solution has, and is prepared to have, a mole ratio between:
the original amount of PCA used for preparing the protein solution, and
the content of BLG of the protein solution
   of 1:1-6:1, more preferably 1.1:1-5:1, even more preferably 1.3:1-4:1, and most preferably 1.5:1-3:1.

The protein solution is prepared by combining, and preferably mixing, appropriate amounts of the sources described herein to obtain a protein solution having the desired characteristics. Preferably step c) is performed under conditions that do not lead to significant protein denaturation.

It is often preferred that the mixing of at least step c) is performed by inline mixing, particularly when at least steps b), c), and d) are implemented as a continuous process.

In some preferred embodiments of the invention step c) is performed under conditions that lead to less than 15% protein denaturation of the BLG of the source comprising BLG, more preferably less 10%, even more preferably less 5%, and most preferably less than 2%.

The protein solution is preferably an aqueous solution. Preferably, at least 90% w/w of the nonsolid matter, i.e. the matter that does not contribute to the solids content of the protein solution, of the protein solution is water, more preferably at least 95% w/w, and most preferably at least 99% w/w.

The protein solution is preferably prepared with a temperature that does not cause protein denaturing, preferably in the range of 0-70 degrees C., and more preferably in the range of 5-65 degrees C., even more preferably in the range of 10-60 degrees C., and most preferably in the range of 20-55 degrees C.

In other preferred embodiments of the present invention the protein solution is prepared to have a temperature in the range of 0-50 degrees C., more preferably in the range of 2-45 degrees C., even more preferably in the range of 5-40 degrees C., and most preferably in the range of 10-35 degrees C. These ranges of temperatures are often preferred if dissolved dioxygen is intended to contribute with a significant portion of the PCA oxidation.

Preferably, the protein solution is prepared by mixing the portion of the source comprising one or more PCA obtained from step a), the source comprising BLG obtained from step a), and optionally with further ingredients.

In some preferred embodiments of the present invention the method does not comprise a step of oxidizing a portion of the source comprising one or more PCA prior to step c), i.e. the method does not comprise step b).

In other preferred embodiments of the present invention the method comprises step b), i.e. oxidizing a portion of the source comprising one or more PCA prior to the preparation of the protein solution, and the protein solution is prepared by mixing a portion of the source comprising one or more oxidized PCA obtained from step b) with the source comprising BLG, and optionally with further ingredients.

It is often preferred that most if not all PCA-type oxidation is performed during step b).

In some preferred embodiments of the present invention, at less than 20% of the PCA-type oxidation takes place during step d), more preferably at most 10%, even more preferably at most 5%, and most preferably at most 2% of the PCA-type oxidation takes place during step d).

Preferably, further ingredients comprise water, one or more acids, one or more bases, one of more pH buffers, one or more oxidizing agents, or mixtures thereof.

In step d) of the method, the protein solution is incubated within a temperature range and for a duration sufficient to reduce the amount of free thiol groups of the protein solution to at most 10 micromol/g protein. If the method does not involve step b), step d) also involves a PCA-type oxidation capable of converting a PCA to a quinone. This oxidation may e.g. be achieved by a chemical oxidizing agent added during the production of the protein solution and/or by electrochemical oxidation during step d). In some preferred embodiments of the present invention the method involves both step b) and PCA-type oxidation during step d).

In the context of the present invention the term “the incubating protein solution” refers to the protein solution during step d).

In some preferred embodiments of the present invention the incubation reduces, and is therefore performed to reduce, the amount of free thiol of the protein solution to at most 9 micromol/g protein, more preferably at most 8 micromol/g protein, more preferably at most 5 micromol/g protein, even more preferably at most 3 micromol/g protein, and most preferably at most 2 micromol/g protein.

In other preferred embodiments of the present invention the incubation reduces, and is therefore performed to reduce, the amount of free thiol of the protein solution to 0.001-10 micromol/g protein, more preferably 0.01-9 micromol/g protein, even more preferably 0.02-8 micromol/g protein, even more preferably 0.03-5 micromol/g protein, even more preferably 0.04-3 micromol/g protein, and most preferably 0.04-2 micromol/g protein.

In some preferred embodiments of the present invention the incubating protein solution has a pH in the range of 6.7-9.5, even more preferably 7.1-9.0, even more preferably 7.3-8.7, and most preferably 7.4-8.5.

In some preferred embodiments of the present invention during the incubation of step d) the protein solution is subjected to a pressure in the range of 1-1000 bar, more preferably 20-500 bar, even more preferably 30-300 bar, and most preferably 40-200 bar.

In some preferred embodiments of the present invention during the incubation of step d) the protein solution has a temperature in the range of 0-160 degrees C., more preferably 10-155 degrees C., even more preferably 15-150 degrees C., and most preferably 20-145 degrees C.

In other preferred embodiments of the present invention the incubating protein solution, i.e. the protein solution during step d), has a has a temperature in the range of 0-67 degrees C., more preferably 10-65 degrees C., even more preferably 15-60 degrees C., and most preferably 20-55 degrees C.

Preferably, the incubating protein solution has a temperature in the range of 5-65 degrees C., more preferably 10-65 degrees C., even more preferably 30-60 degrees C., and most preferably 40-55 degrees C.

In other preferred embodiments, the incubating protein solution has a temperature in the range of 60-98 degrees C., more preferably 65-95 degrees C., and most preferably 70-90 degrees C.

In some embodiments of the invention, the pH of the incubating protein solution is in the range 6.5-7.0 and its temperature is in the range of 40-65 degrees C., more preferably 45-65 degrees C., even more preferably 50-65 degrees C., and most preferably 55-65 degrees C.

In other preferred embodiments of the present invention, the pH of the incubating protein solution of step d) is in the range 7.1-9.5 and its temperature is in the range of 5-65 degrees C., more preferably 10-65 degrees C., even more preferably 30-60 degrees C., and most preferably 40-55 degrees C.

In further preferred embodiments of the present invention, the pH of the incubating protein solution of step d) is in the range 8.5-9.5 and its temperature is in the range of 0-65 degrees C., more preferably 0-50 degrees C., even more preferably 0-30 degrees C., and most preferably 5-25 degrees C.

The inventors have found that it is particularly preferred that the pH of the incubating protein solution of step d) is in the range 7.5-8.5 and that its temperature is in the range of 5-60 degrees C., more preferably 10-60 degrees C., even more preferably 15-60 degrees C., and most preferably 20-60 degrees C. These ranges seem to favour both selective modification of the free thiol of BLG and relatively fast kinetics of the reaction.

Additionally, the inventors have found that it is particularly preferred that the pH of the incubating protein solution of step d) is in the range 7.7-8.5 and that its temperature is in the range of 25-55 degrees C., more preferably 30-55 degrees C., even more preferably 35-50 degrees C., and most preferably 35-45 degrees C. These ranges also seem to favour both selective modification of the free thiol of BLG and relatively fast kinetics of the reaction.

In further preferred embodiments of the present invention, the pH of the incubating protein solution of step d) is in the range 7.5-8.5 and that its temperature is in the range of 60-98 degrees C., more preferably 65-95 degrees C., and most preferably 70-90 degrees C.

In even preferred embodiments of the present invention, the pH of the incubating protein solution of step d) is in the range 7.5-8.5 and that its temperature is in the range of 45-160 degrees C., more preferably 50-155 degrees C., and most preferably 55-150 degrees C.

In some preferred embodiments of the present invention the duration of the incubation is at most 12 hours, more preferably at most 6 hours, even more preferably at most 3 hours, and most preferably at most 1 hour.

An advantage of the present method is that it can be operated with a relatively short incubation time. Thus, in further preferred embodiments of the present invention the duration of the incubation of step d) is at most 30 minutes, more preferably at most 10 minutes, even more preferably at most 5 minutes, and most preferably at most 2 minutes.

The inventors have seen indications that even shorter incubations are technically feasible. Thus, in even further preferred embodiments of the present invention the duration of the incubation of step d) is at most 100 seconds, more preferably at most 60 seconds, even more preferably at most 30 seconds, and most preferably at most 20 seconds.

In some preferred embodiments of the present invention the oxidation of step d) is involves contacting PCA with a chemical oxidizing agent in the protein solution under conditions that convert at least some of the PCA to quinones. Additional a chemical oxidizing agent(s) may be added during the incubation of step d).

One or more of the chemical oxidizing agent(s) used in step b) and/or step d) should be capable of PCA-type oxidation during step d) and/or step b).

In further preferred embodiments of the present invention the chemical oxidizing agent comprises, or even consists of, a peroxide, ozone, dioxygen, or a combination thereof.

In particular preferred embodiments of the present invention the chemical oxidizing agent comprises, or even consists of, hydrogen peroxide, benzoyl peroxide, or a combination thereof.

In some preferred embodiments of the present invention the oxidation of step d) involves electrochemical oxidation of PCA of the protein solution under conditions that convert at least some of the PCA to quinones.

The potential difference should be selected sufficiently high to enable oxidization of PCA to quinones and can be determined as described above in relation to step b).

Preferably, the electrochemical oxidation of step d) is performed using a potential difference of −0.1-1.5 V, and most preferably −0.05-0.7 V.

In some preferred embodiments of the invention the protein solution has a pH in the range of 7.1-9.0 and the electrochemical oxidation is performed using a potential difference of −0.1 to 0.9 V, and more preferably −0.05 to 0.8 V, and most preferably 0 to 0.7 V.

In other preferred embodiments of the invention the protein solution has a pH in the range of 7.3-8.7 and the electrochemical oxidation is performed using a potential difference of −0.1 to 0.8V, and most preferably 0 to 0.7V.

In further preferred embodiments of the invention the protein solution has a pH in the range of 7.4-8.5 and the electrochemical oxidation is performed using a potential difference of −0.1 to 0.8, and most preferably −0.05 to 0.7V.

Features and embodiments relating to the implementation of electrochemical oxidation described in the context of step b) also applies to the electrochemical oxidation of step d) except for the acidic pH-ranges suggested in the context of step b).

In some preferred embodiments of the present invention the temperature of a first stage of the incubation is in the range of 0-60 degrees C., more preferably 10-50 degrees, and the incubating protein solution subsequently is heated to a temperature in the range of 70-160 degrees C., more preferably 100-150 degrees C. in a second stage of the incubation.

The use of high temperatures during step d) is particularly useful if the incubating protein solution is to be used as a packaged, ready-to-drink beverage, and which has to be filled into suitable containers immediately after step d).

In some preferred embodiments of the present invention, step d) furthermore comprises addition of further PCA to the incubating protein solution.

In some preferred embodiments the invention the mole ratio between:
the total amount of PCA provided to protein solution in steps c) and d), and
the content of BLG provided to the protein solution in steps c) and d)
   is in the range of 0.1:1-1000:1, more preferably 0.2:1-500:1, even more preferably 5:1 200:1, and most preferably 10:1-100:1.

In further preferred embodiments the mole ratio between:
the total amount of PCA provided to protein solution in steps c) and d), and
the content of BLG provided to the protein solution in steps c) and d)
   is in the range of 0.1:1-100:1, more preferably 0.1:1-50:1, even more preferably 0.1:1 20:1, and most preferably 0.1:1-10:1.

In even further preferred embodiments the mole ratio between:
the total amount of PCA provided to protein solution in steps c) and d), and
the content of BLG provided to the protein solution in steps c) and d)
   is in the range of 0.1:1-6:1, more preferably 0.2:1-5:1, even more preferably 0.3:1-4:1, and most preferably 0.4:1-3:1.

In some preferred embodiments the mole ratio between:
the total amount of PCA provided to protein solution in steps c) and d), and
the content of BLG provided to the protein solution in steps c) and d)
   is in the range of 1:1-1000:1, more preferably 2:1-500:1, even more preferably 5:1 200:1, and most preferably 10:1-100:1.

In further preferred embodiments the mole ratio between:
the total amount of PCA provided to protein solution in steps c) and d), and
the content of BLG provided to the protein solution in steps c) and d)
   is in the range of 1:1-100:1, more preferably 1:1-50:1, even more preferably 1:1-20:1, and most preferably 1:1-10:1.

In even further preferred embodiments of the invention the mole ratio between:
the total amount of PCA provided to protein solution in steps c) and d), and
the content of BLG provided to the protein solution in steps c) and d)
   is in the range of 1:1-6:1, more preferably 1.1:1-5:1, even more preferably 1.3:1-4:1, and most preferably 1.5:1-3:1.

In some preferred embodiments of the present invention the PCA-type oxidation applied during step b) and/or step d) is sufficient to create a mole ratio between:
the theoretical amount of quinone provided to the protein solution during the method determined according to Analysis 1, and
the content of BLG of the protein solution
   of at least 0.1:1, more preferably at least 0.2:1.

In further preferred embodiments of the present invention the oxidation applied during step b) and/or step d) is sufficient to create a mole ratio between:
the theoretical amount of quinone provided to the protein solution during the method determined according to Analysis 1, and
the content of BLG of the protein solution
   of 0.1:1-100:1, more preferably 0.1:1-50:1, even more preferably 0.2:1-15:1, and most preferably 0.2:1-5:1.

In even further preferred embodiments of the present invention the oxidation applied during step b) and/or step d) is sufficient to create a mole ratio between:
the theoretical amount of quinone provided to the protein solution during the method determined according to Analysis 1, and
the content of BLG of the protein solution
   of 0.1:1-5:1, more preferably 0.1:1-4:1, even more preferably 0.2:1-3:1, and most preferably 0.2:1-2:1.

In other preferred embodiments of the present invention the PCA-type oxidation applied during step b) and/or step d) is sufficient to create a mole ratio between:
the theoretical amount of quinone provided to the protein solution during the method determined according to Analysis 1, and
the content of BLG of the protein solution
   of at least 1.1:1, more preferably at least 1.3:1, even more preferably at least 1.5:1, and most preferably at least 2:1.

In further preferred embodiments of the present invention the oxidation applied during step b) and/or step d) is sufficient to create a mole ratio between:
the theoretical amount of quinone provided to the protein solution during the method determined according to Analysis 1, and
the content of BLG of the protein solution
   of 1:1-100:1, more preferably 1:1-50:1, even more preferably 1:1-15:1, and most preferably 1.5:1-5:1.

If the PCA oxidation mainly or exclusively takes place in step b) it is often preferred that the PCA-type oxidation applied during step b) is sufficient to create a mole ratio between:
the quinone content of the portion of the source comprising one or more oxidized PCA that is used in the protein solution, and
the content of BLG of the protein solution
   of at least 1.1:1, more preferably at least 1.3:1, even more preferably at least 1.5:1, and most preferably at least 2:1.

This is e.g. the case when PCA-type oxidation performed during of step d) accounts for less than 20% of the PCA-type oxidation.

In the above-mentioned preferred embodiments of the present invention it is even more preferred that the oxidation applied during step b) is sufficient to create a mole ratio between:
the quinone content of the portion of the source comprising one or more oxidized PCA that is used in the protein solution, and
the content of BLG of the protein solution
   of 1:1-100:1, more preferably 1:1-50:1, even more preferably 1:1-15:1, and most preferably 1.5:1-5:1.

In some preferred embodiments of the present invention the method does not involve oxidation of a portion of the source comprising one or more PCA prior to step c), i.e. no step b), and the PCA-type oxidation is performed by a chemical oxidizing agent.

Alternatively, but also preferred, the method does not involve oxidation of a portion of the source comprising one or more PCA prior to step c), i.e. no step b), and the oxidation of PCA is performed by electrochemical oxidization.

In some preferred embodiments of the present invention the method comprises step b) and the portion of the source comprising one or more oxidized PCA obtained from step b) is used for the preparation of the protein solution of step c), and the oxidation of PCA is performed by a chemical oxidizing agent.

In further preferred embodiments of the present invention the method comprises step b) and the portion of the source comprising one or more oxidized PCA obtained from step b) is used for the preparation of the protein solution of step c), and the oxidation of PCA is performed by electrochemical oxidization.

In other preferred embodiments of the present invention the method comprises oxidation of the PCA during step d), and preferably involves oxidation of PCA during step d) by electrochemical oxidization.

If the PCA oxidation mainly or exclusively takes place in step d) it is often preferred that the PCA-type oxidation applied during step d) is sufficient to create a mole ratio between:
the theoretical amount of quinone provided to the protein solution during the method determined according to Analysis 1, and
the content of BLG of the protein solution
   of at least 0.1:1, more preferably at least 0.2:1, even more preferably at least 0.2:1, and most preferably at least 0.2:1.

This is e.g. the case when PCA-type oxidation performed during of step d) accounts for at least 50% of the PCA-type oxidation during the method.

In other preferred embodiments of the invention the PCA-type oxidation applied during step d) is sufficient to create a mole ratio between:
the theoretical amount of quinone provided to the protein solution during the method determined according to Analysis 1, and
the content of BLG of the protein solution
   of 0.1:1-100:1, more preferably 0.1:1-50:1, even more preferably 0.2:1-15:1, and most preferably 0.2:1-5:1.

In even further preferred embodiments of the invention the PCA-type oxidation applied during step d) is sufficient to create a mole ratio between:
the theoretical amount of quinone provided to the protein solution during the method determined according to Analysis 1, and
the content of BLG of the protein solution
   of 0.1:1-5:1, more preferably 0.1:1-4:1, even more preferably 0.2:1-3:1, and most preferably 0.2:1-2:1.

In some preferred embodiments of the invention the PCA-type oxidation applied during step d) is sufficient to create a mole ratio between:
the theoretical amount of quinone provided to the protein solution during the method determined according to Analysis 1, and
the content of BLG of the protein solution
   of at least 1.1:1, more preferably at least 1.3:1, even more preferably at least 1.5:1, and most preferably at least 2:1.

In the above-mentioned preferred embodiments of the present invention it is even more preferred that the PCA-type oxidation applied during step d) is sufficient to create a mole ratio between:
the theoretical amount of quinone provided to the protein solution during the method determined according to Analysis 1, and
the content of BLG of the protein solution
   of 1:1-100:1, more preferably 1:1-50:1, even more preferably 1:1-15:1, and most preferably 1.5:1-5:1.

Step d) may furthermore comprise a step of reducing the content the unreacted PCA and oxidized PCA of the incubated protein solution. This may e.g. involve subjection the incubated protein solution to a separation step such as dialysis, nanofiltration, ultrafiltration, or chromatography. Ultrafiltration is particularly preference and may be implemented with diafiltration.

In some preferred embodiments of the invention, the product resulting from step d) is a protein concentrate of the incubated protein solution.

In some preferred embodiments of the present invention, the method comprises step e) of drying a liquid feed comprising at least the protein derived from the incubated protein solution of step d).

In other preferred embodiments of the present invention, the method comprises step e) of drying a liquid feed comprising at least the solids derived from the incubated protein solution of step d).

In some preferred embodiments of the present invention, the liquid feed for drying comprises or even consists of the protein solution obtained from step d) or a protein concentrate thereof.

It is particularly preferred that the liquid feed for drying is a protein concentrate of the protein solution obtained from step d).

In the context of the present invention, a “protein concentrate” of a first liquid is a second liquid in which at least the protein originate from the first liquid but which has a higher protein content relative to total solids than the first liquid. Preferably, substantially all solids of the protein concentrate originate from the first liquid. A “protein concentrate” of a first liquid is preferably prepared by ultrafiltration, nanofiltration, reverse osmosis, and/or evaporation. Protein concentration ultrafiltration and/or nanofiltration may e.g. be implemented with diafiltration to wash out some of the small non-protein solids. A “protein concentrate” contains the same protein species and preferably has the same weight percentage of the whey protein species relative to total protein as the first liquid. The provision of a protein concentrate may also involve one or more pH adjustments.

In other preferred embodiments of the present invention the liquid feed is prepared by subjecting the incubated protein solution of step d) to one or more of:
a pH adjustment,
a concentration step,
a diafiltration, and
a heat-treatment.

In some preferred embodiments of the invention the preparation of the liquid feed of step e) involves subjecting the protein solution obtained from step d), i.e. the incubated protein solution to ultrafiltration/diafiltration, preferably performed to an extent sufficient to reduce the weight percentage of free phenolic compounds relative to total solids by at least 30%, more preferably at least 50%, even more preferably at least 80%, and most preferably at least 90%. Such ultrafiltration/diafiltration is preferably performed using an ultrafiltration membrane which, during operation, retains protein but allows for the permeation of molecules having a molecular weight less than 2000 Da.

In some preferred embodiments of the invention step e) furthermore involves a pH adjustment which provides the liquid feed with a pH in the range of 6.0-8.5, and most preferably 6.5-7.5.

Preferably, step e) involves spray-drying the liquid feed.

Useful examples of spray-drying are e.g. described in WO 2018/115520 A1.

The method of the invention can be implemented as a batch process, a semi-batch process, or a continuous process. Continuous processes are particularly preferred.

In some preferred embodiments of the invention at least steps b), c) and d) are implemented as a continuous process.

An aspect of the invention pertains to a protein composition comprising modified BLG and having at most 10 micromol free thiol groups per g protein, said protein composition is obtainable by the method of the invention and preferably has one or more of:
a protein content of at least 30% w/w relative to total solids,
a tryptophan content of at least 0.7% w/w relative to total protein,
a methionine content of at least 0.3% w/w relative to total protein,
a kynurenine content of at most 0.2 micrograms/mg protein,
preferably, a fat content of at most 3% w/w relative to total solids,
preferably, a content of protein-bound sulfur in the range of 100-600 micromol/g protein,
preferably, a content of protein-bound cysteine residues that form disulfide bonds in the range of 150-400 micromol/g protein.

In some preferred embodiments of the invention the protein composition comprising modified BLG is protein solution obtained from step d), i.e. the incubated protein solution.

In other preferred embodiments of the invention the protein composition comprising modified BLG is the liquid feed prepared during step e).

In further preferred embodiments of the invention the protein composition comprising modified BLG is the powder by step e). It is therefore often preferred that the protein composition comprising modified BLG is obtainable steps a), c), d) and e) of the present method

In some preferred embodiments of the present invention, the protein of the protein composition has an average molecular weight in the range of 18 kDa and 10000 kDa, more preferably between 50-8000 kDa, and most preferably 80-5000 kDa.

In a particular preferred embodiments of the present invention the protein composition has an average molecular weight of the protein in the range of 18 kDa and 500 kDa, more preferably between 18-100 kDa, and most preferably 18-40 kDa.

The protein composition typically has a pH in the range of 5.5-9.5.

In some preferred embodiments of the invention, the protein composition has a pH in the range of 5.5-9.5, more preferably 6.0-8.5, even more preferably 6.2-8.0, and most preferably 6.5-7.5.

In some preferred embodiments of the invention, the protein composition has a total protein content of at least 30% w/w relative to the total solids of the protein composition, more preferably at least 50% w/w, even more preferably at least 75% w/w and most preferably at least 85% w/w relative to the total solids of the protein composition.

Preferably, the protein composition has a total protein content in the range of 30-99% w/w relative to the total solids of the protein composition, more preferably 50-97% w/w, even more preferably 75-96% w/w, and most preferably at least 85-95% w/w relative to the total solids of the protein composition.

In some preferred embodiments of the invention the protein composition has a total fat content of at most 10% w/w relative to total solids, more preferably at most 8% w/w, and most preferably at most 6% w/w relative to total solids.

In other preferred embodiments of the invention the protein composition has a total fat content of at most 5% w/w relative to total solids, more preferably at most 2% w/w, even more preferably at most 0.5% w/w, and most preferably at most 0.1% w/w relative to total solids.

In further preferred embodiments of the invention the protein composition has a total fat content in the range of 1-20% w/w relative to total solids, more preferably in the range of 2-16% w/w, even more preferably in the range of 3-12% w/w, and most preferably at most 4-10% w/w relative to total solids.

Even lower levels of fat are typically preferred and it is often preferred that the protein composition has a total fat content of at most 1% w/w relative to total solids, more preferably at most 0.5% w/w, even more preferably at most 0.2% w/w, and most preferably at most 0.1% w/w relative to total solids.

The protein composition may contain carbohydrate in various amounts.

However, it is often preferred that the protein composition has a carbohydrate content of at most 65% w/w relative to total solids.

Even lower levels of carbohydrate are typically preferred and it is often preferred that the protein composition has a carbohydrate content of at most 20% w/w relative to total solids, more preferably at most 8% w/w, even more preferably at most 2% w/w, and most preferably at most 0.2% w/w relative to total solids.

The protein composition preferably has an ash content of at most 8% w/w relative to total solids, more preferably at most 6% w/w, even more preferably at most 5% and most preferably at most 4.0%.

In some preferred embodiments of the present invention, the protein composition has an ash content of 0.4-8% w/w relative to total solids, more preferably 0.5-6% w/w, even more preferably 0.5-5% w/w and most preferably 0.6-4.0% w/w relative to total solids.

The protein composition preferably has a combined content of magnesium and calcium at most 1% w/w relative to total solids, more preferably at most 0.7% w/w, even more preferably at most 0.5% and most preferably at most 0.2%.

In some preferred embodiments of the present invention, the protein composition has combined content of magnesium and calcium of 0.01-1% w/w relative to total solids, more preferably 0.001-0.7% w/w, even more preferably 0.01-0.5% w/w and most preferably 0.01-0.2% w/w relative to total solids.

The inventors have seen indications that protein composition that contain even up to 15 micromol free thiol groups/g protein can provide a reduced level of unpleasant odours, relative to non-modified whey protein, in heat-treated whey protein beverages that contain 3% whey protein.

In some preferred embodiments of the invention, the protein composition comprises free thiol groups in an amount of at most 15 micromol/g protein, more preferably at most 14 micromol/g protein, even more preferably at most 13 micromol/g protein, and most preferably at most 12 micromol/g protein.

In some preferred embodiments of the invention, the protein composition comprises free thiol groups in an amount of 0.001-15 micromol/g protein, more preferably 0.01-14 micromol/g protein, even more preferably 0.01-13 micromol/g protein, and most preferably 0.01-12 micromol/g protein.

However, it is often preferred that the protein composition contains lower levels of free thiol groups, particularly when the protein composition is to be used for heat-treated, high protein beverages, e.g. containing 6% whey protein or higher. Thus, in some preferred embodiments of the invention the protein composition comprises free thiol groups in an amount of at most 10 micromol/g protein, more preferably at most 8 micromol/g protein, more preferably at most 5 micromol/g protein, even more preferably at most 3 micromol/g protein, and most preferably at most 2 micromol/g protein.

Preferably, the protein composition comprises free thiol groups in an amount of 0.01-10 micromol/g protein, more preferably 0.01-8 micromol/g protein, more preferably 0.01-5 micromol/g protein, even more preferably 0.01-3 micromol/g protein, and most preferably 0.01-2 micromol/g protein.

Even lower levels of free thiol groups may be desired, and in some preferred embodiments of the invention, the protein composition comprises free thiol groups in an amount of at most 1 micromol/g protein, more preferably at most 0.7 micromol/g protein, even more preferably at most 0.5 micromol/g protein, and most preferably at most 0.2 micromol/g protein.

In some preferred embodiments of the invention, the protein composition has a tryptophan content of at least 0.7% w/w relative to total protein, more preferably at least 0.8% w/w, even more preferably at least 0.9% w/w, and most preferably at least 1.0% w/w relative to total protein.

Preferably, the protein composition has a tryptophan content of 0.7-3% w/w relative to total protein, more preferably 0.8-2.6% w/w, even more preferably 0.9-2.4% w/w, and most preferably 1.0-2.2% w/w relative to total protein.

Alternatively, but also preferred, the protein composition often has a tryptophan content of 0.7-3% w/w relative to total protein, more preferably 0.8-3% w/w, even more preferably 0.9-3% w/w, and most preferably 1.0-3% w/w relative to total protein.

In some preferred embodiments of the invention, the protein composition has a methionine content of at least 0.3% w/w relative to total protein, more preferably at least 0.4% w/w, even more preferably at least 0.5% w/w, and most preferably at least 0.6% w/w relative to total protein.

Preferably, the protein composition has a methionine content of 0.3-3.3% w/w relative to total protein, more preferably 0.4-3.2% w/w, even more preferably 0.5-3.2% w/w, and most preferably 0.6-3.2% w/w relative to total protein.

Increased lower limits of methionine are often preferred, and in some preferred embodiments of the present invention the protein composition has a methionine content of 1.0-3.3% w/w relative to total protein, more preferably 1.3-3.2% w/w, even more preferably 1.6-3.2% w/w, and most preferably 1.8-3.2% w/w relative to total protein.

Preferably, the protein composition has a kynurenine content of at most 0.2 micrograms/mg protein, more preferably at most 0.05 micrograms/mg protein, even more preferably at most 0.01 micrograms/mg protein, and most preferably at most 0.001 micrograms/mg protein. It is particularly preferred that the protein composition does not contain detectable kynurenine.

The content of kynurenine is quantified according to Poojary et al.; “Selective and sensitive UHPLC-ESI-Orbitrap MS method to quantify protein oxidation markers”; Talanta, Volume 234, 1 Nov. 2021 (available online July 2021).

Kynurenine is a useful marker of tryptophan oxidation, it is believed by the inventors to be partially responsible for the development of yellow colour in heat-sterilized protein beverages based on protein that has been subjected to excessive oxidation, and it is furthermore not desired from a health perspective.

Preferably, the protein composition has a content of protein-bound sulfur in the range of 100-600 micromol/g protein, more preferably in the range of 200-500 micromol/g protein, and most preferably in the range of 250-500 micromol/g protein.

Preferably, the protein composition has a content of protein-bound cysteine residues that form disulfide bonds in the range of 150-400 micromol/g protein, more preferably 160-350, and most preferably 170-300 micromol/g protein.

The inventors have found that it is advantageous that the particle size of the protein of protein composition is no larger than 10000 kDa and preferably smaller to avoid the development of opaqueness in transparent beverage applications and furthermore to avoid increased viscosity during concentration and drying of the protein.

In some preferred embodiments of the invention, the protein composition has a weight average molecular weight of the protein in the range of 18 kDa and 10000 kDa, more preferably 30-9000 kDa, even more preferably 50-8000 kDa, and most preferably 80-5000 kDa.

Preferably, at least 60% w/w of the protein of the protein composition has a molecular weight between 18 kDa and 10000 kDa, more preferably at least 80% w/w, even more preferably at least 90% w/w, and most preferably at least 99% w/w.

More preferably, at least 60% w/w of the protein of the protein composition has a molecular weight between 50 kDa and 8000 kDa, more preferably at least 80% w/w, even more preferably at least 90% w/w, and most preferably at least 99% w/w.

Even more preferably, at least 60% w/w of the protein of the protein composition has a molecular weight between 80 kDa and 5000 kDa, more preferably at least 80% w/w, even more preferably at least 90% w/w, and most preferably at least 99% w/w.

In other preferred embodiments of the invention, the protein composition has a weight average molecular weight of the protein in the range of 18 kDa and 200 kDa, more preferably between 30-150 kDa, and most preferably between 30-100 kDa.

The inventors have found that the smaller the weight average molecular weight of the protein the higher total protein concentration is feasible during concentration, e.g. by ultrafiltration or nanofiltration, prior to spray-drying.

Preferably, at least 60% w/w of the protein of the protein composition has a molecular weight between 18 kDa and 200 kDa, more preferably at least 80% w/w, even more preferably at least 90% w/w, and most preferably at least 99% w/w.

More preferably, at least 60% w/w of the protein of the protein composition has a molecular weight between 18 kDa and 150 kDa, more preferably at least 80% w/w, even more preferably at least 90% w/w, and most preferably at least 99% w/w.

Even more preferably, at least 60% w/w of the protein of the protein composition has a molecular weight between 18 kDa and 100 kDa, more preferably at least 80% w/w, even more preferably at least 90% w/w, and most preferably at least 99% w/w.

The inventors has seen indications that it may be beneficial that a significant protein of the protein composition has a molecular weight of at least 30 kDa, which may be due to dimerisation of modified BLG.

Thus, preferably, at least 60% w/w of the protein of the protein composition has a molecular weight between 30 kDa and 200 kDa, more preferably at least 80% w/w, even more preferably at least 90% w/w, and most preferably at least 99% w/w.

More preferably, at least 60% w/w of the protein of the protein composition has a molecular weight between 30 kDa and 150 kDa, more preferably at least 80% w/w, even more preferably at least 90% w/w, and most preferably at least 99% w/w.

Even more preferably, at least 60% w/w of the protein of the protein composition has a molecular weight between 30 kDa and 100 kDa, more preferably at least 80% w/w, even more preferably at least 90% w/w, and most preferably at least 99% w/w.

In some preferred embodiments of the invention, the protein composition of the invention is obtainable by the method described herein.

In some preferred embodiments of the invention, the protein composition is in the form of a liquid, and preferably an aqueous liquid. The protein composition in the form of a liquid preferably has a solids content of 0.1-50% w/w, more preferably 1-35% w/w, even more preferably 5-30% w/w, and most preferably 10-30% w/w.

In some preferred embodiments of the invention, the protein composition is in the form of a solid, and preferably a powder which preferably has been prepared by spray-drying. The protein composition in the form of a powder preferably has a solids content of at least 90% w/w, more preferably at least 93% w/w, even more preferably at least 94% w/w, and most preferably at least 95% w/w.

The part of the protein composition and the oxidizing whey protein solution that does not contribute to the solids content is preferably water.

The part of the protein composition that does not contribute to the solids content preferably comprises water in an amount of at least 80% w/w, more preferably at least 90% w/w, even more preferably at least 95% w/w, and more preferably at least 99% w/w.

In a particularly preferred embodiment of the invention the protein composition has:
a protein content of at least 86% w/w relative to total solids, and most preferably at least 90% relative to total solids,
a fat content of at most 1% w/w relative to total solids, and most preferably at most 0.2%,
at most 10 micromol free thiol groups/g protein, and most preferably at most 5 micromol free thiol groups/g protein,
a tryptophan content of 0.7-3% w/w relative to total protein, and most preferably 1.0-3% w/w relative to total protein,
a methionine content of 0.3-3.3% w/w relative to total protein, and most preferably 1.3-3.2% w/w relative to total protein,
a kynurenine content of at most 0.2 micrograms/mg protein, and most preferably at most 0.01 micrograms/mg protein.

In the above-mentioned particularly preferred embodiment of the invention, the oxidized whey protein composition preferably has:
a content of protein-bound sulfur in the range of 100-600 micromol/g protein, and
a content of protein-bound cysteine residues that form disulfide bonds in the range of 150-400 micromol/g protein.

Additionally, in the above-mentioned particularly preferred embodiment of the invention, the protein composition preferably has:
a content of protein-bound sulfur in the range of 100-600 micromol/g protein, and
a content of protein-bound cysteine residues that form disulfide bonds in the range of 150-400 micromol/g protein.

It is furthermore often preferred that at least 60% w/w of the protein of the protein composition of the above-mentioned particularly preferred embodiment has a molecular weight between 30 kDa and 9000 kDa, more preferably at least 80% w/w, even more preferably at least 90% w/w, and most preferably at least 99% w/w.

The pH of the above-mentioned particularly preferred embodiment of the protein composition is preferably in the range of 6.2-8.0, and most preferably 6.5-7.5.

In some preferred embodiments of the present invention the protein composition is a sterile protein composition, and preferably a packaged, sterile protein composition. Preferably in the form of a sterile, liquid protein composition or a sterile, powdered, protein composition.

Another aspect of the invention pertains to a process for producing a heat-treated, preferably heat-sterilized, beverage, the process comprising the following steps:
1) mixing the protein composition of the invention with one or more further beverage ingredients to obtain a liquid mixture having a pH of 5.5-8.5, and
2) filling the liquid mixture into suitable containers, the process furthermore comprising at least one heat-treatment step wherein the liquid mixture is heat-treated, and preferably heat-sterilized, prior to filling and/or after filling.

In some preferred embodiments of the present invention the beverage mixture comprises the protein composition in an amount sufficient to contribute with at least 0.5% w/w protein.

Thus, a more specific aspect of the invention pertains to a process of producing a heat-treated, and preferably heat-sterilized, beverage having a pH of 5.5-8.5, more preferably 6.5-7.5, the process comprises:
1) combining the protein composition as described herein with one or more further ingredients to obtain a liquid mixture having a pH of 5.5-8.5, more preferably 6.5-7.5, and comprising:
   the protein composition in an amount sufficient to contribute with at least 0.5% w/w protein, and
   water,
2) packaging the liquid mixture in a container, preferably a sterile container, and wherein the liquid mixture is heat-treated, and preferably heat-sterilised, prior to and/or after packaging.

The protein composition as described herein is preferably the only protein source of the food product or of the heat-sterilized beverage, and therefore also of the liquid mixture.

The inventors have found that it is advantageous that the content of free thiol groups of the liquid mixture is kept low prior to the heat treatment to prevent the formation of unpleasant odours similar to the odour of rotten eggs.

Thus, in some preferred embodiments of the invention, the liquid mixture contains, prior to the heat-sterilisation, at most 60 micromol free thiol groups/100 g liquid mixture, more preferably at most 40 micromol free thiol groups/100 g liquid mixture, even more preferably at most 30 micromol free thiol groups/100 g liquid mixture, and most preferably at most 30 micromol free thiol groups/100 g liquid mixture.

Even lower contents of free thiol groups are often required, and in some preferred embodiments of the invention the liquid mixture contains, prior to the heat-sterilisation, at most 20 micromol free thiol groups/100 g liquid mixture, more preferably at most 15 micromol free thiol groups/100 g liquid mixture, even more preferably at most 10 micromol free thiol groups/100 g liquid mixture, and most preferably at most 5 micromol free thiol groups/100 g liquid mixture.

The liquid mixture preferably comprising a total amount of protein in the range of 0.5-15% w/w relative to the weight of the liquid mixture, more preferably 1-10% w/w relative to the weight of the liquid mixture, even more preferably 2-9% w/w relative to the weight of the liquid mixture, and most preferably 3-8% w/w relative to the weight of the liquid mixture.

Alternatively, but also preferred, the liquid mixture may comprise a total amount of protein in the range of 4-15% w/w relative to the weight of the liquid mixture, more preferably 5-14% w/w relative to the weight of the liquid mixture, even more preferably 6-13% w/w relative to the weight of the liquid mixture, and most preferably 8-12% w/w relative to the weight of the liquid mixture.

The protein composition of the invention preferably contributes with at least 30% w/w of the total protein of the liquid mixture, more preferably at least 50% w/w of the total protein, even more preferably at least 70% w/w of the total protein, and most preferably at least 80% w/w of the total protein.

Even higher contributions are often preferred, and in some preferred embodiments of the present invention, the protein composition of the invention contributes with at least 90% w/w of the total protein of the liquid mixture, more preferably at least 95% w/w of the total protein, even more preferably at least 99% w/w of the total protein, and most preferably 100% w/w of the total protein.

If the protein composition is used in combination with other protein sources. It is preferred to use sources that have a relatively low content of free thiol groups.

In some preferred embodiments of the present invention, the liquid mixture comprises total protein in an amount of at least 15% w/w relative to total solids, more preferably at least 20% w/w, and most preferably at least 25% w/w, and most preferably at least 30% w/w relative to total solids.

The total protein may contribute with an even larger portion of the total solids, e.g. when the beverage is intended as a sports protein beverage. Thus, in some preferred embodiments of the present invention, the liquid mixture comprises total protein in an amount of at least 80% w/w relative to total solids, more preferably at least 90% w/w, even more preferably at least 92% w/w, and most preferably at least 94% w/w relative to total solids.

The liquid mixture typically has a solids content of 0.5-50% w/w, more preferably 1-35% w/w, even more preferably 2-20% w/w, and most preferably 3-10% w/w.

The part of the liquid mixture that is not made up of solids preferably comprises water. The part of the liquid mixture that is not made up of solids preferably comprises water in an amount of at least 80% w/w, more preferably at least 90% w/w, even more preferably at least 95% w/w, and more preferably at least 99% w/w.

In some preferred embodiments of the present invention, the liquid mixture has a calorie content of at most 100 kcal/100 g, more preferably at most 80 kcal/100 g, even more preferred at most 70 kcal/100 g, and most preferably at most 60 kcal/100 g. Preferably, the liquid mixture may have a calorie content of 2-100 kcal/100 g, more preferably at 4-80 kcal/100 g, even more preferred 8-70 kcal/100 g, and most preferably 12-60 kcal/100 g. These embodiments are preferred for e.g. sports applications where the protein source is a primary energy source.

In other preferred embodiments of the present invention, the liquid mixture has a calorie content of more than 100 kcal/100 g, more preferably at least 120 kcal/100 g, even more preferred at least 140 kcal/100 g, and most preferably at least 150 kcal/100 g. Preferably, the liquid mixture may have a calorie content of 101-300 kcal/100 g, more preferably at 120-280 kcal/100 g, even more preferred 140-270 kcal/100 g, and most preferably 150-260 kcal/100 g. These embodiments are preferred for e.g. clinical nutrition where the protein source is accompanied by substantial amounts of carbohydrate and fat.

The compositional features and preferences described in the context of the heat-treated beverage described in pages 65-81 of PCT application no. PCT/EP2022/078739 equally apply to the liquid mixture.

The pH of the liquid mixture may span from slightly acidic to slightly alkaline.

Near-pH-neutral liquid mixtures are particularly preferred for the production of near-pH neutral beverages. In some preferred embodiments of the present invention, the liquid mixture has a pH in the range of 5.5-8.0, more preferably 6.0-7.5, even more preferred 6.2-7.3, and most preferred 6.3-7.2.

In other preferred embodiments of the present invention, the liquid mixture has a pH in the range of 6.0-7.5, more preferably 6.2-7.5, and most preferred 6.3-7.5.

In further preferred embodiments of the present invention, the liquid mixture has a pH in the range of 6.0-8.0, more preferably 6.6-7.7, even more preferred 6.7-7.6, and most preferred 6.8-7.5.

Generally, any suitable food acid or food base may be used to adjust the pH of the liquid mixture. Those skilled in the art will recognize suitable means for adjusting the pH. Suitable food bases include sodium or potassium carbonate, sodium or potassium hydrogen carbonate, or ammonium hydroxide. Alternatively, KOH or NaOH may be employed to adjust the pH. Suitable food acids include e.g. citric acid, hydrochloric acid, malic acid or tartaric acid or phosphoric acid.

In some preferred embodiments of the present invention, the liquid mixture has a viscosity of at most 200 cP at 20 degrees C. and at a shear rate of 300 s⁻¹, more preferably at most 100 cP at 20 degrees C. and at a shear rate of 300 s⁻¹, even more preferred at most 50 cP at 20 degrees C. and a shear rate of 300 s⁻¹, and most preferred at most 20 cP at 20 degrees C. and a shear rate of 300 s⁻¹.

The liquid mixture is typically prepared by mixing the appropriate ingredients with the oxidized whey protein composition. If powder ingredients are used, it is often preferred that these are allowed to hydrate prior to the heat-treatment and similarly if may be preferred that the liquid mixture is homogenized prior to the heat-treatment.

In some preferred embodiments, the protein composition is provided in the form of a powder, and is preferably mixed water or an aqueous liquid and allow to hydrate prior to the heat-treatment.

In other preferred embodiments, the protein composition is provided in the form of a liquid, e.g. the protein solution obtained from step d) of the present method. The protein composition obtained from step d) if then:
mixed with one or more further ingredients required to produce the beverage,
optionally subjected to homogenisation,
subjected to heat-sterilisation by heating it to a temperature in the range of 140-150 degrees for 1-10 seconds,
cooled, and
filled into suitable sterile containers, which are subsequently sealed.

The packaging of step 2) may be any suitable packaging technique, and any suitable container may be used for packaging the liquid mixture.

However, in a preferred embodiment of the invention, the packaging of step 2) is aseptic packaging, i.e. the liquid mixture is packaged under aseptic conditions. For example, the aseptic packaging may be performed by using an aseptic filling system, and it preferably involves filling the liquid mixture into one or more aseptic container(s).

Aseptic filling and sealing are particularly preferred if the liquid mixture already is sterile or very low in microorganisms prior to filling.

Examples of useful containers are bottles, cartons, bricks, and/or bags.

The heat-treatment of the process preferably subjects the liquid mixture to a temperature of at least 70 degrees C.

In some preferred embodiments of the inventive process, the liquid mixture of step 1) is subjected to a heat-treatment comprising at least pasteurisation and then packaged in step 2).

In another embodiment of the inventive process, the packaged liquid mixture of step 2) is subjected to a heat-treatment comprising at least pasteurisation.

In some preferred embodiments, the heat-treatment involves heating the liquid mixture to a temperature in the range of 70-80 degrees C.

In some preferred embodiments of the invention, the temperature of the heat-treatment is in the range of 70-80 degrees C., preferably in the range of 70-79 degrees C., more prefer-ably in the range of 71-78 degrees C., even more preferably in the range of 72-77 degrees C., and most preferably in the range of 73-76 degrees C., such as approx. 75 degrees C.

Preferably, the duration of the heat-treatment, when performed in the temperature range 70-80, for 1 second to 60 minutes. The highest exposure times are best suited for the lowest temperatures of the temperature range and vice versa.

In other preferred embodiments, the temperature of the heat-treatment is at 70 degrees C. for at least 60 minutes, or preferably at 75 degrees C. for at least 45 minutes, or preferably at 80 degrees C. for at least 30 minutes, or preferably at 85 degrees C. for at least 22 minutes, or preferably at 90 degrees C. for at least 10 minutes.

In particularly preferred embodiments of the invention, the heat-treatment provides 70-78 degrees C. for 1 second to 30 minutes, more preferably 71-77 degrees C. for 1 minute to 25 minutes, and even more preferred 72-76 degrees C. for 2 minutes to 20 minutes.

In some preferred embodiments of the invention, the process of the heat-treatment involves heating to a temperature of 85° C.-95 degrees C. for 1 to 30 minutes.

For example, the temperature of the heat-treatment may be at least 81 degrees C., prefer-ably at least 91 degrees C., preferably at least 95 degrees C., more preferred at least 100 degrees C., even more preferred at least 120 degrees C., and most preferred at least 140 degrees C.

In some particularly preferred embodiments of the invention, the heat-treatment involves heating the liquid mixture to a temperature in the range of 100-160 degrees C. for a duration sufficient to sterilize the liquid mixture. This preferably involves heating the liquid mixture to a temperature in the range of 120 to 155 degrees C. for a duration sufficient to obtain sterility, typically 0.1 seconds to 10 minutes, and more preferably 140 to 155 degrees C. for a duration sufficient to obtain sterility, typically for 0.1-30 seconds. A heat-treatment of a liquid that renders the liquid sterile is also referred to as a heat-sterilisation.

Another preferred heat-treatment is a sterilizing UHT-type treatment which typically involves a temperature in the range of 135-146 degrees C. and for a duration sufficient to obtain sterility, typically a duration in the range of 1-10 seconds.

Alternatively, but also preferred, the heat-treatment may involve a temperature in the range of 145-180 degrees C. and for a duration sufficient to obtain sterility, typically a duration in the range of 0.01-2 seconds, and more preferably a temperature in the range of 150-180 degrees C. and a duration in the range of 0.01-0.3 seconds.

The implementation of the heat-treatment may involve the use of equipment such as a plate or tubular heat exchanger, scraped surface heat exchanger or a retort system. Alter-natively, and particularly preferred for heat-treatments above 95 degrees C., direct steam-based heating may be employed, e.g. using direct steam injection, direct steam infusion, or spray-cooking. Additionally, such direct steam-based heating is preferably used in combination with flash cooling. Suitable examples of implementation of spray-cooking are found in WO2009113858A1, which is incorporated herein for all purposes. Suitable examples of implementation of direct steam injection and direct steam infusion are found in WO2009113858A1 and WO 2010/085957 A3, which are incorporated herein for all purposes. General aspects of high-temperature treatment are e.g. found in “Thermal technologies in food processing” ISBN 185573558 X, which is incorporated herein by reference for all purposes.

In some preferred embodiments of the invention, the heat-treatment involves, or even consists of, retort heat-treatment, preferably at a temperature of at least 80 degrees C., and more preferably at a temperature of at least 95 degrees C., even more preferably at least 100 degrees C., and most preferably at least 120 degrees C., and preferably for a duration sufficient to render the treated liquid sterile.

In other preferred embodiments of the invention, the heat-treatment involves, or even consists of, steam infusion or spray cooking, preferably at a temperature of at least 100 degrees C., and more preferably at a temperature of at least 120 degrees C., even more preferably at least 130 degrees C., and most preferably at least 140 degrees C., and preferably for a duration sufficient to render the treated liquid sterile.

In some preferred embodiments of the invention, pasteurisation is combined with a physical microbial reduction.

Useful examples of physical microbial reduction involve one or more of germ filtration, UV radiation, high pressure treatment, pulsed electric field treatment, and ultrasound.

In some preferred embodiments of the invention, the heat-treatment is a sterilizing heat-treatment and hence results in a sterile liquid mixture and therefore a sterile beverage. Such sterilisation may e.g. be obtained by combining germ filtration and pasteurisation or by performing heat-treatment at at least 100 degrees C. and for a duration sufficient to obtain sterilisation.

It is beneficial that the liquid mixture is subjected to cooling after the heat-treatment. According to a preferred embodiment of the inventive process, following the heat-treatment, the heat-treated liquid mixture is cooled to preferably 0 to 70 degrees C., preferably 0 to 60 degrees C., even more preferably 0 to 30 degrees C., and most preferably 0-20 degrees C.

If the heat-treatment does not sterilize the liquid mixture, the heat-treated liquid mixture is preferably cooled to 0 to 15 degrees C. after the heat-treatment, more preferably to 1 to 10 degrees C., and most preferably 1-5 degrees C.

The cooling may take place prior to a filling step or after a filling step.

The cooling typically involve flash cooling and/or conventional heat-exchangers.

At least partial cooling by flash cooling is often preferred, particularly after heat-sterilizing heat-treatment. Flash cooling typically strips some of the volatile compounds of the cooled liquid. Whey protein beverages having a pH in the range of 5.5-8.5 are particularly prone to the development of unpleasant odours during heat-treatment and these unpleasant odours are partially stripped from the heat-treated liquid and released in the proximity of the flash cooling system. This is a disadvantage as it exposes the personnel operating the heat-treatment system to an annoying smell and may furthermore be associated with health is-sues.

The inventors have found that, advantageously, the flash-cooling of heat-treated beverages based on the present protein compositions releases much less and some-times even none of such unpleasant odours.

The process of the invention can be implemented as a batch process, a semi-batch process, or a continuous process.

Another specific aspect of the invention pertains to a process of producing a heat-treated, and preferably heat-sterilized beverage, comprising:
performing steps a), c), and d), or
performing steps a), b) c), and d),
   of the method described herein to obtain the protein composition on liquid form and subsequently packaging the protein composition or a liquid feed prepared from the protein composition which packaging is according to step 2) of the process as described above.

If the protein composition is to be used directly as a beverage is preferred that step d) involves a heat-sterilizing heat-treatment, i.e. a heat-treatment that renders the treated liquid sterile.

Such as a heat-treatment typically requires that the liquid to be treated is heated to a temperature in the range of 100-160 degrees C. for a duration sufficient to sterilize the liquid. Suitable time/temperature combinations for such as heat-treatments are described herein.

Yet another aspect of the invention pertains to a heat-treated, preferably heat-sterilized, beverage having a pH of 5.5-8.5 obtainable by the process of the invention.

Yet another aspect of the invention pertains to a heat-treated, preferably heat-sterilized, beverage having a pH of 5.5-8.5, and more preferably 6.5-7.5, the beverage comprising the protein composition of the invention in an amount sufficient to contribute with at least 0.5% w/w protein, and preferably having a content of H2S 7 days after production of at most 5 micromol/L, more preferably at most 3 micromol/L, even more preferably at most 1.0 micromol/L, and most preferably at most 0.7 micromol/L.

A further aspect of the invention pertains to a food ingredient comprising:
the solids of the protein composition of the invention, and
one or more further ingredient(s), preferably selected from:
   a dairy ingredient, preferably a non-oxidized dairy ingredient,
   a plant-based ingredient,
   a non-dairy carbohydrate source,
   a flavouring agent, and/or
   a sweetener, e.g. in the form of a sweet carbohydrate, a polyol and/or a high intensity sweetener.

Preferably, the sweetener comprises one or more of a carbohydrate sweetener, a polyol, a high intensity sweetener, and a combination thereof.

In one embodiment of the invention, the beverage comprises at least one high-intensity sweetener (HIS). At least one HIS is preferably selected from the group consisting of aspartame, cyclamate, sucralose, acesulfame salt, neotame, saccharin, stevia extract, a steviol glycoside such as e.g. rebaudioside A, or a combination thereof.

In some embodiments of the invention, it is particularly preferred that the sweetener comprises or even consists of one or more high-intensity sweeteners.

HIS is both found among both natural and artificial sweeteners and typically have a sweetening intensity of at least 10 times that of sucrose.

If used, the total amount of HIS of the beverage is typically in the range of 0.001-2% w/w. Preferably, the total amount of HIS is in the range of 0.005-1% w/w. Most preferably, the total amount of HIS is in the range of 0.01-0.5% w/w.

The choice of the sweetener may depend on the beverage to be produced, e.g. high-intensity sweeteners (e.g. aspartame, acesulfame-K or sucralose) may be used in beverages where no energy contribution from the sweetener is desired, whereas for beverages having a natural profile natural sweeteners (e.g. steviol glycosides, sorbitol or sucrose) may be used.

It may furthermore be preferred that the sweetener comprises or even consists of one or more polyol sweetener(s). Non-limiting examples of useful polyol sweeteners are maltitol, mannitol, lactitol, sorbitol, inositol, xylitol, threitol, galactitol or combinations thereof. If used, the total amount of polyol sweetener of the beverage is typically in the range of 1-20% w/w. More preferably the total amount of polyol sweetener of the beverage is in the range of 2-15% w/w. Even more preferably, the total amount of polyol sweetener may be in the range of 4-10% w/w.

Yet an aspect of the invention pertains to the use of a protein composition comprising modified BLG, preferably the protein composition comprising modified BLG of the invention, as a food ingredient, preferably for:
improving the odour, and/or
reducing the level of unpleasant odour similar to the odour of rotten eggs, and/or
reducing the development of H2S during production, and/or
reducing the content of H2S in the headspace of the container,
   of heat-sterilized, beverages having a pH in the range of 5.5-8.5, preferably having a whey protein content of at least 3% w/w, and preferably heat-sterilized using indirect heat-treatment.

Total protein, pH, viscosity, content of H2S, content of total and free thiol groups, content of amino acids, amino acid oxidation, average molecular weight, intrinsic viscosity, sensory evaluation, content of native proteins, content of total fat, content of lactose, mineral composition, and turbidity are quantified or determined according to the Analyses A-Q of PCT application no. PCT/EP2022/078739 which is incorporated by reference herein for all purposes.

Preferred embodiments of the invention are described in the following numbered embodiments.

Numbered embodiment 1. A method of producing a protein composition comprising modified BLG, the method comprising the steps of:
a) providing:
   a source comprising one or more phenolic compounds that contain at least two hydroxyl groups bound directly to the same aromatic ring (PCA), and
   a source comprising BLG,
b) optionally subjecting a portion of the source comprising one or more PCA to a type of oxidation capable of converting a PCA to a quinone (PCA-type oxidation) thereby providing a source comprising one or more oxidized PCA,
c) combining a portion of the source comprising one or more PCA and/or a portion of the source comprising one or more oxidized PCA with a source comprising BLG and optionally with further ingredients to provide a protein solution, said protein solution having:
   a pH in the range of 6.5-9.5, and
   a BLG content of at least 0.2% w/w,
   a mole ratio between:
      the original amount of PCA used for preparing the protein solution, and
      the content of BLG of the protein solution,
of at least 0.1:1,
d) incubating the protein solution within a temperature range and for a duration sufficient to reduce the amount of free thiol groups of the protein solution to at most 10 micromol/g protein, with the proviso that if the method does not contain step b), step d) also involves application of a type of oxidation capable of converting a PCA to a quinone,
preferably, wherein the PCA-type oxidation applied during step b) and/or step d) is sufficient to create a mole ratio between:
   the theoretical amount of quinone provided to the protein solution during the method determined according to Analysis 1, and
   the amount of BLG of the protein solution
of at least 0.1:1.

Numbered embodiment 1.1. A method of producing a protein composition comprising modified BLG, the method comprising the steps of:
a) providing:
   a source comprising one or more phenolic compounds that contain at least two hydroxyl groups bound directly to the same aromatic ring (PCA), and
   a source comprising BLG,
b) optionally subjecting a portion of the source comprising one or more PCA to a type of oxidation capable of converting a PCA to a quinone (PCA-type oxidation) thereby providing a source comprising one or more oxidized PCA,
c) combining a portion of the source comprising one or more PCA and/or a portion of the source comprising one or more oxidized PCA with a source comprising BLG and optionally with further ingredients to provide a protein solution, said protein solution having:
   a pH in the range of 6.5-9.5, and
   a BLG content of at least 0.2% w/w,
   a mole ratio between:
      the original amount of PCA used for preparing the protein solution, and
      the content of BLG of the protein solution,
of at least 1:1,
d) incubating the protein solution within a temperature range and for a duration sufficient to reduce the amount of free thiol groups of the protein solution to at most 10 micromol/g protein, with the proviso that if the method does not contain step b), step d) also involves application of a type of oxidation capable of converting a PCA to a quinone,
preferably, wherein the PCA-type oxidation applied during step b) and/or step d) is sufficient to create a mole ratio between:
   the theoretical amount of quinone provided to the protein solution during the method determined according to Analysis 1, and
   the amount of BLG of the protein solution
of at least 1:1.

Numbered embodiment 2. The method according to numbered embodiment 1 or 1.1, furthermore comprising a step e) of drying a liquid feed comprising at least the protein derived from the incubated protein solution of step d).

Numbered embodiment 3. The method according to any one of the preceding numbered embodiments wherein the PCA comprises a flavonoid, preferably a flavanol or a flavanol ester, e.g. catechin, epicatechin, gallocatechin, epigallocatechin, catechin 3-gallate, epicatechin 3-gallate, gallo-catechin 3-gallate, and epigallocatechin 3-gallate (EGCG).

Numbered embodiment 4. The method according to any one of the preceding numbered embodiments wherein the PCA comprises a stilbenoid, preferably resveratrol.

Numbered embodiment 5. The method according to any one of the preceding numbered embodiments wherein the PCA comprises caffeic acid, gallic acid, chlorogenic acid, catechol, 4-methyl catechol, catechin, epicatechin, gallocatechin, epigallocatechin, catechin 3-gallate, epicatechin 3-gallate, gallocatechin 3-gallate, epigallocatechin 3-gallate (EGCG), resveratrol, carnosic acid, carnosol, naringenin, or a mixture thereof.

Numbered embodiment 6. The method according to any one of the preceding numbered embodiments wherein the PCA has a molecular weight of at most 600 g/mol, more preferably at most 400 g/mol, even more preferably at most 250 g/mol, and more preferably at most 200 g/mol.

Numbered embodiment 7. The method according to any one of the preceding numbered embodiments wherein the PCA has a molecular weight in the range of 110-600 g/mol, more preferably 110-400 g/mol, even more preferably 110-350 g/mol, and more preferably 110-310 g/mol.

Numbered embodiment 7.1. The method according to any one of the preceding numbered embodiments wherein the PCA has a molecular weight in the range of 120-1000 g/mol, more preferably 250-700 g/mol, even more preferably 300-650 g/mol, and more preferably 350-600 g/mol.

Numbered embodiment 8. The method according to any one of the preceding numbered embodiments wherein the PCA does not contain a carboxylic acid group.

Numbered embodiment 9. The method according to any one of the preceding numbered embodiments wherein the PCA has a water solubility of at least 8 mM at 25 degrees C., more preferably at least 12 mM, and most preferably at least 16 mM.

Numbered embodiment 10. The method according to any one of the preceding numbered embodiments wherein the source comprising one or more PCA is selected from the group consisting of a polyphenol extract from a herb, a polyphenol extract from a spice, polyphenol extract from a fruit, polyphenol extract from a berry, and mixtures thereof.

Numbered embodiment 10.1. The method according to any one of the preceding numbered embodiments wherein the source comprising one or more PCA is selected from the group consisting of a polyphenol extract of tea, more preferably a polyphenol extract of green tea; a polyphenol extract of coffee; polyphenol extract of cocoa; a polyphenol extract of grapes; a polyphenol extract of rosemary; a polyphenol extract of lemon balm; a polyphenol extract of black currant; a single PCA-isolate, and mixtures thereof.

Numbered embodiment 11. The method according to any one of the preceding numbered embodiments wherein the source comprising one or more PCA comprises PCA in an amount of at least 25% w/w relative to the total solids of the source comprising one or more PCA, more preferably at least 40% w/w, even more preferably at least 60% w/w, and most preferably at least 80% w/w relative to the total solids of the source comprising one or more PCA.

Numbered embodiment 12. The method according to any one of the preceding numbered embodiments wherein the source comprising one or more PCA is a single PCA-isolate comprising at single PCA in an amount of at least 25% w/w relative to the total solids of the source comprising one or more PCA, more preferably at least 40% w/w, even more preferably at least 60% w/w, and most preferably at least 80% w/w relative to the total solids of the source comprising one or more PCA.

Numbered embodiment 13. The method according to any one of the preceding numbered embodiments wherein the source comprising BLG comprises, or even consists of, a whey protein concentrate, a whey protein isolate, a milk serum protein concentration, a milk serum protein isolate, a BLG isolate, or a combination thereof.

Numbered embodiment 14. The method according to any one of the preceding numbered embodiments comprising step b) of subjecting a portion of the source comprising one or more PCA to a type of oxidation capable of converting a PCA to a quinone thereby providing a source comprising one or more oxidized PCA.

Numbered embodiment 15. The method according to numbered embodiment 14 wherein the oxidation of step b) involves preparing an oxidizing aqueous solution comprising the portion of the source comprising one or more PCA, optionally a chemical oxidizing agent and optionally one or more further ingredients such as water.

Numbered embodiment 16. The method according to numbered embodiment 15 wherein the oxidizing aqueous solution has a content of PCA of at least 0.2 mM, more preferably at least 15 mM, and most preferably at least 50 mM.

Numbered embodiment 17. The method according to numbered embodiment 15 or 16 wherein the oxidizing aqueous solution has a concentration of PCA of 0.2-600 mM, more preferably 15-550 mM, and most preferably 50-500 mM.

Numbered embodiment 18. The method according to any one of numbered embodiments 15-17 wherein the oxidizing aqueous solution has a pH in the range of 2-9.5, more preferably 6.5-9.5, even more preferably 7.1-9.0, even more preferably 7.3-8.7, and most preferably 7.4-8.5.

Numbered embodiment 19. The method according to any one of numbered embodiments 15-17 wherein the oxidizing aqueous solution has a pH in the range of 2-6.4, more preferably 3.0-6.0, even more preferably 3.5-5.5, and most preferably 4.0-5.0.

Numbered embodiment 20. The method according to any one of numbered embodiments 14-17 wherein the oxidation of step b) involves contacting the portion of the source comprising one or more PCA with a chemical oxidizing agent under conditions that convert at least some of the PCA to quinones.

Numbered embodiment 21. The method according to numbered embodiment 20 wherein the chemical oxidizing agent comprises, or even consists of, a peroxide, ozone, dioxygen, or a combination thereof.

Numbered embodiment 22. The method according to numbered embodiment 20 or 21 wherein the chemical oxidizing agent comprises, or even consists of, hydrogen peroxide, benzoyl peroxide, or a combination thereof.

Numbered embodiment 23. The method according to any one of numbered embodiments 14-22 wherein the oxidation of step b) involves preparing an oxidizing aqueous solution comprising the portion of the source comprising one or more PCA, the chemical oxidizing agent and optionally one or more further ingredients such as water.

Numbered embodiment 24. The method according to any one of numbered embodiments 14-23 wherein the oxidation of step b) involves electrochemical oxidation of the portion of the source comprising one or more PCA under conditions that convert at least some of the PCA to quinones.

Numbered embodiment 25. The method according to numbered embodiment 24 wherein the oxidation of step b) involves preparing an oxidizing aqueous solution comprising the portion of the source comprising one or more PCA, and optionally one or more ingredients such as water.

Numbered embodiment 26. The method according to numbered embodiment 24 or 25 wherein the electrochemical oxidation is operated using a potential difference of −0.1-1.5 V, more preferably 0.0-1.2 V, and most preferably 0.0 to 0.7 V.

Numbered embodiment 27. The method according to any one of numbered embodiments 25-26 wherein the oxidizing aqueous solution has a pH in the range of 6-9 and the electrochemical oxidation is operated using a potential difference of −0.1 to 0.9, even more preferably 0-0.8 V, and most preferably 0.2-0.7 V.

Numbered embodiment 28. The method according to any one of numbered embodiments 25-26 wherein the oxidizing aqueous solution has a pH in the range of 3-5 and the electrochemical oxidation is operated using a potential difference of 0.1-1.3 V, and more preferably 0.2-0.9 V, and most preferably 0.3-0.7 V.

Numbered embodiment 28.1. The method according to any one of numbered embodiments 24-28 wherein the electrochemical oxidation is performed at a temperature in the range of 2-80 degrees C., more preferably 5-60 degrees C., even more preferably 10-40 degrees C., and most preferably in the range of 15-30 degrees C.

Numbered embodiment 28.2. The method according to any one of numbered embodiments 24-28 wherein the electrochemical oxidation is performed at a temperature in the range of 30-90 degrees C., more preferably 40-90 degrees C., even more preferably 50-90 degrees C., and most preferably in the range of 60-90 degrees C.

Numbered embodiment 28.3. The method according to any one of numbered embodiments 24-28 wherein the electrochemical oxidation is performed at a temperature in the range of 5-25 degrees C., more preferably 10-25 degrees C., even more preferably 15-25 degrees C., and most preferably in the range of 18-25 degrees C.

Numbered embodiment 29. The method according to any one of the preceding numbered embodiments wherein the protein solution has a pH in the range of 6.7-9.5, even more preferably 7.1-9.0, even more preferably 7.3-8.7, and most preferably 7.4-8.5.

Numbered embodiment 30. The method according to any one of the preceding numbered embodiments wherein the protein solution has a BLG content of at least 0.5% w/w, more preferably at least 1% w/w, even more preferably at least 3% w/w, and most preferably at least 6% w/w.

Numbered embodiment 31. The method according to any one of the preceding numbered embodiments wherein the protein solution has a BLG content of 0.5-30% w/w, more preferably 1-20% w/w, even more preferably 3-16% w/w, and most preferably 5-12% w/w.

Numbered embodiment 32. The method according to any one of the preceding numbered embodiments wherein the protein solution has a BLG content of at least 30% w/w relative to total protein, more preferably at least 40% w/w relative to total protein, even more preferably at least 45% w/w relative to total protein, and most preferably at least 50% w/w relative to total protein.

Numbered embodiment 33. The method according to any one of the preceding numbered embodiments wherein the protein solution has a BLG content of 30-99% w/w relative to total protein, more preferably 40-95% w/w relative to total protein, even more preferably 45-90% w/w relative to total protein, and most preferably 50-80% w/w relative to total protein.

Numbered embodiment 34. The method according to any one of the preceding numbered embodiments wherein the protein solution has a BLG content of at least 60% w/w relative to total protein, more preferably at least 80% w/w relative to total protein, even more preferably at least 90% w/w relative to total protein, and most preferably at least 95% w/w relative to total protein Numbered embodiment 35. The method according to any one of the preceding numbered embodiments wherein the protein solution has a BLG content of at least 30% w/w relative to total solids, more preferably at least 40% w/w relative to total solids, even more preferably at least 45% w/w relative to total solids, and most preferably at least 50% w/w relative to total solids.

Numbered embodiment 36. The method according to any one of the preceding numbered embodiments wherein the protein solution has a BLG content of 30-99% w/w relative to total solids, more preferably 40-95% w/w relative to total solids, even more preferably 45-90% w/w relative to total solids, and most preferably 50-80% w/w relative to total solids.

Numbered embodiment 37. The method according to any one of the preceding numbered embodiments wherein the protein solution has a BLG content of at least 60% w/w relative to total solids, more preferably at least 80% w/w relative to total solids, even more preferably at least 90% w/w relative to total solids, and most preferably at least 95% w/w relative to total solids.

Numbered embodiment 38. The method according to any one of the preceding numbered embodiments wherein the protein solution has a total fat content of at most 5% w/w relative to total solids, more preferably at most 2% w/w, even more preferably at most 0.5% w/w, and most preferably at most 0.1% w/w relative to total solids.

Numbered embodiment 39. The method according to any one of the preceding numbered embodiments wherein the protein solution has a total fat content in the range of 1-20% w/w relative to total solids, more preferably in the range of 2-16% w/w, even more preferably in the range of 3-12% w/w, and most preferably 4-10% w/w relative to total solids.

Numbered embodiment 40. The method according to any one of the preceding numbered embodiments wherein the protein solution has a total carbohydrate content of at most 10% w/w relative to total solids, more preferably at most 8% w/w, even more preferably at most 6% w/w, and most preferably at most 5% w/w relative to total solids.

Numbered embodiment 41. The method according to any one of the preceding numbered embodiments wherein the protein solution has a total carbohydrate content of at most 2% w/w relative to total solids, more preferably at most 1% w/w, even more preferably at most 0.5% w/w, and most preferably at most 0.2% w/w relative to total solids.

Numbered embodiment 42. The method according to any one of the preceding numbered embodiments wherein the protein solution of step c) has a mole ratio between:
the original amount of PCA used for preparing the protein solution, and
the content of BLG of the protein solution of 0.1:1-100:1, more preferably 0.1:1-50:1, even more preferably 0.1:1-20:1, and most preferably 0.1:1-10:1.

Numbered embodiment 42.1. The method according to any one of the numbered embodiments 1-41 wherein the protein solution of step c) has a mole ratio between:
the original amount of PCA used for preparing the protein solution, and
the content of BLG of the protein solution
   of 0.1:1-5:1, more preferably 0.1:1-4:1, even more preferably 0.2:1-3:1, and most preferably 0.3:1-2:1.

Numbered embodiment 42.2. The method according to any one of the numbered embodiments 1-41 wherein the protein solution has a mole ratio between:
the original amount of PCA used for preparing the protein solution, and
the content of BLG of the protein solution,
   of at least 1.5:1, more preferably at least 2:1, even more preferably at least 5:1, and most preferably at least 10:1.

Numbered embodiment 42.3. The method according to any one of the numbered embodiments 1-41 wherein the protein solution of step c) has a mole ratio between:
the original amount of PCA used for preparing the protein solution, and
the content of BLG of the protein solution,
   of at least 1:1.

Numbered embodiment 43. The method according to any one of the numbered embodiments 1-41 wherein the protein solution has a mole ratio between:
the original amount of PCA used for preparing the protein solution, and
the content of BLG of the protein solution,
   of 1:1-1000:1, more preferably 2:1-500:1, even more preferably 5:1-200:1, and most preferably 10:1-100:1.

Numbered embodiment 44. The method according to any one of the numbered embodiments 1-41 wherein the protein solution has a mole ratio between:
the original amount of PCA used for preparing the protein solution, and
the content of BLG of the protein solution
   of 1:1-100:1, more preferably 1:1-50:1, even more preferably 1:1-20:1, and most preferably 1:1-10:1.

Numbered embodiment 44.1. The method according to any one of the numbered embodiments 1-41 wherein the protein solution has a mole ratio between:
the original amount of PCA used for preparing the protein solution, and
the content of BLG of the protein solution
   of 1:1-6:1, more preferably 1.1:1-5:1, even more preferably 1.3:1-4:1, and most preferably 1.5:1-3:1.

Numbered embodiment 45. The method according to any one of the preceding numbered embodiments wherein the protein solution is prepared by mixing the portion of the source comprising one or more PCA obtained from step a), the source comprising BLG obtained from step a), and optionally with further ingredients.

Numbered embodiment 46. The method according to any one of the preceding numbered embodiments wherein the method does not comprise a step of oxidizing a portion of the source comprising one or more PCA prior to step c).

Numbered embodiment 47. The method according to any one of the numbered embodiments 1-45 wherein the method comprises step b) and wherein the protein solution is prepared by mixing the portion of the source comprising one or more oxidized PCA obtained from step b) with the source comprising BLG, and optionally with further ingredients.

Numbered embodiment 47.1. The method according to any one of the preceding numbered embodiments wherein the incubation reduces, or is performed to reduce, the amount of free thiol of the protein solution to at most 9 micromol/g protein, more preferably at most 8 micromol/g protein, more preferably at most 5 micromol/g protein, even more preferably at most 3 micromol/g protein, and most preferably at most 2 micromol/g protein.

Numbered embodiment 48. The method according to any one of the preceding numbered embodiments wherein the protein solution, during the incubation, is subjected to a pressure in the range of 1-1000 bar, more preferably 20-500 bar, even more preferably 30-300 bar, and most preferably 40-200 bar.

Numbered embodiment 49. The method according to any one of the preceding numbered embodiments wherein the protein solution during the incubation has a temperature in the range of 0-160 degrees C., more preferably 10-155 degrees C., even more preferably 15-150 degrees C., and most preferably 20-145 degrees C.

Numbered embodiment 49.1. The method according to any one of the preceding numbered embodiments wherein the protein solution is prepared to have a temperature in the range of 0-50 degrees C., more preferably in the range of 2-45 degrees C., even more preferably in the range of 5-40 degrees C., and most preferably in the range of 10-35 degrees C.

Numbered embodiment 50. The method according to any one of the preceding numbered embodiments wherein the duration of the incubation is at most 12 hours, more preferably at most 6 hours, even more preferably at most 3 hours, and most preferably at most 1 hour.

Numbered embodiment 51. The method according to any one of the preceding numbered embodiments wherein the duration of the incubation is at most 30 minutes, more preferably at most 10 minutes, even more preferably at most 5 minutes, and most preferably at most 2 minutes.

Numbered embodiment 52. The method according to any one of the preceding numbered embodiments wherein the oxidation of step d) involves contacting PCA with a chemical oxidizing agent in the protein solution under conditions that convert at least some of the PCA to quinones.

Numbered embodiment 53. The method according to numbered embodiment 52 wherein the chemical oxidizing agent comprises, or even consists of, a peroxide, ozone, dioxygen, or a combination thereof.

Numbered embodiment 54. The method according to numbered embodiment 52 or 53 wherein the chemical oxidizing agent comprises, or even consists of, hydrogen peroxide, benzoyl peroxide, or a combination thereof.

Numbered embodiment 55. The method according to any one of the preceding numbered embodiments wherein the oxidation of step d) involves electrochemical oxidation of PCA of the protein solution under conditions that convert at least some of the PCA to quinones.

Numbered embodiment 56. The method according to any one of the preceding numbered embodiments wherein the electrochemical oxidation of step d) is performed using a potential difference of −0.1-1.5 V, and most preferably −0.05-0.7 V.

Numbered embodiment 57. The method according to any one of the preceding numbered embodiments wherein the oxidation of step d) involves the protein solution having a pH in the range of 7.1-9.0 and the electrochemical oxidation is performed using a potential difference of −0.1 to 0.9 V, and more preferably −0.05 to 0.8 V, and most preferably 0 to 0.7 V.

Numbered embodiment 57.1. The method according to any one of the preceding numbered embodiments wherein the oxidation of step d) involves the protein solution having a pH in the range of 7.3-8.7 and the electrochemical oxidation is performed using a potential difference of −0.1 to 0.8V, and most preferably 0 to 0.7V.

Numbered embodiment 57.2. The method according to any one of the preceding numbered embodiments wherein the oxidation of step d) involves the protein solution having a pH in the range of 7.4-8.5 and the electrochemical oxidation is performed using a potential difference of −0.1 to 0.8, and most preferably −0.05 to 0.7V.

Numbered embodiment 58. The method according to any one of the preceding numbered embodiments wherein the temperature of a first stage of the incubation is in the range of 0-60 degrees C., more preferably 10-50 degrees, and wherein the incubating protein solution subsequently is heated to a temperature in the range of 70-160 degrees C., more preferably 80-150 degrees C. in a second stage of the incubation.

Numbered embodiment 59. The method according to any one of the preceding numbered embodiments wherein the oxidation applied during step b) and/or step d) is sufficient to create a mole ratio between:
the theoretical amount of quinone provided to the protein solution during the method determined according to Analysis 1, and
the content of BLG of the protein solution
   of 0.1:1-100:1, more preferably 0.1:1-50:1, even more preferably 0.2:1-15:1, and most preferably 0.2:1-5:1.

Numbered embodiment 59.1. The method according to any one of the preceding numbered embodiments wherein the oxidation applied during step b) and/or step d) is sufficient to create a mole ratio between:
the theoretical amount of quinone provided to the protein solution during the method determined according to Analysis 1, and
the content of BLG of the protein solution
   of 0.1:1-5:1, more preferably 0.1:1-4:1, even more preferably 0.2:1-3:1, and most preferably 0.2:1-2:1.

Numbered embodiment 59.2. The method according to any one of the preceding numbered embodiments wherein the oxidation applied during step d) is sufficient to create a mole ratio between:
the theoretical amount of quinone provided to the protein solution during the method determined according to Analysis 1, and
the content of BLG of the protein solution
   of 0.1:1-100:1, more preferably 0.1:1-50:1, even more preferably 0.2:1-15:1, and most preferably 0.2:1-5:1.

Numbered embodiment 59.3. The method according to any one of the preceding numbered embodiments wherein the oxidation applied during step d) is sufficient to create a mole ratio between:
the theoretical amount of quinone provided to the protein solution during the method determined according to Analysis 1, and
the content of BLG of the protein solution
   of 0.1:1-5:1, more preferably 0.1:1-4:1, even more preferably 0.2:1-3:1, and most preferably 0.2:1-2:1.

Numbered embodiment 59.4. The method according to any one of the preceding numbered embodiments wherein the oxidation applied during step b) and/or step d) is sufficient to create a mole ratio between:
the theoretical amount of quinone provided to the protein solution during the method determined according to Analysis 1, and
the content of BLG of the protein solution
   of at least 1:1.

Numbered embodiment 59.5. The method according to any one of the numbered embodiments 1-58 wherein the PCA-type oxidation applied during step b) and/or step d) is sufficient to create a mole ratio between:
the theoretical amount of quinone provided to the protein solution during the method determined according to Analysis 1, and
the mole amount of BLG of the protein solution
   of at least 1.1:1, more preferably at least 1.3:1, even more preferably at least 1.5:1, and most preferably at least 2:1.

Numbered embodiment 60. The method according to any one of the numbered embodiments 1-58 wherein the oxidation applied during step b) and/or step d) is sufficient to create a mole ratio between:
the theoretical amount of quinone provided to the protein solution during the method determined according to Analysis 1, and
the content of BLG of the protein solution
   of 1:1-100:1, more preferably 1:1-50:1, even more preferably 1:1-15:1, and most preferably 1.5:1-5:1.

Numbered embodiment 61. The method according to any one of the numbered embodiments 1-58 wherein the PCA-type oxidation applied during step b) is sufficient to create a mole ratio between:
the quinone content of the portion of the source comprising one or more oxidized PCA that is used in the protein solution, and
the amount of BLG of the protein solution
   of at least 1.1:1, more preferably at least 1.3:1, even more preferably at least 1.5:1, and most preferably at least 2:1.

Numbered embodiment 62. The method according to any one of the numbered embodiments 1-58 wherein the PCA-type oxidation applied during step b) is sufficient to create a mole ratio between:
the quinone content of the portion of the source comprising one or more oxidized PCA that is used in the protein solution, and
the amount of BLG of the protein solution
   of 1:1-100:1, more preferably 1:1-50:1, even more preferably 1:1-15:1, and most preferably 1.5:1-5:1.

Numbered embodiment 62. The method according to any one of the numbered embodiments 1-58 wherein the PCA-type oxidation applied during step d) is sufficient to create a mole ratio between:
the quinone content of the portion of the source comprising one or more oxidized PCA that is used in the protein solution, and
the amount of BLG of the protein solution
   of 1:1-100:1, more preferably 1:1-50:1, even more preferably 1:1-15:1, and most preferably 1.5:1-5:1.

Numbered embodiment 63. The method according to any one of the preceding numbered embodiments:
wherein the method does not involve oxidation of the portion of the source comprising one or more PCA prior to step c), and
wherein the PCA-type oxidation is performed by a chemical oxidizing agent.

Numbered embodiment 64. The method according to any one of the preceding numbered embodiments:
wherein the method does not involve oxidation of the portion of the source comprising one or more PCA prior to step c), and
wherein the PCA-type oxidation is performed by electrochemical oxidization.

Numbered embodiment 65. The method according to any one of the preceding numbered embodiments:
wherein the method comprises step b) and the portion of the source comprising one or more oxidized PCA obtained from step b) is used for the preparation of the protein solution of step c), and
wherein the PCA-type oxidation is performed by a chemical oxidizing agent.

Numbered embodiment 66. The method according to any one of the preceding numbered embodiments:
wherein the method comprises step b) and the portion of the source comprising one or more oxidized PCA obtained from step b) is used for the preparation of the protein solution of step c), and
wherein the PCA-type oxidation is performed by electrochemical oxidization.

Numbered embodiment 67. The method according to any one of the preceding numbered embodiments:
wherein the method comprises step b) and the portion of the source comprising one or more oxidized PCA obtained from step b) is used for the preparation of the protein solution of step c), and
wherein the PCA-type oxidation is performed by both electrochemical oxidization and a chemical oxidizing agent.

Numbered embodiment 68. The method according to any one of numbered embodiments 2-67 comprising step e) of drying a liquid feed comprising at least the solids derived from the incubated protein solution of step d).

Numbered embodiment 69. The method according to any one of numbered embodiments 2-68 wherein the liquid feed for drying comprises or even consists of the protein solution obtained from step d) or a protein concentrate thereof.

Numbered embodiment 70. The method according to any one of numbered embodiments 2-68 wherein the liquid feed is prepared by subjecting the incubated protein solution of step d) to one or more of:
a pH adjustment,
a concentration step,
a diafiltration, and
a heat-treatment.

Numbered embodiment 71. The method according to any one of numbered embodiments 2-70 wherein step e) involves spray-drying the liquid feed.

Numbered embodiment 72. The method according to any one of the preceding numbered embodiments wherein the method is implemented as a batch process, a semi-batch process, or a continuous process.

Numbered embodiment 73. The method according to any one of the preceding numbered embodiments wherein the method is implemented as a continuous process or wherein at least steps b), c) and d) are implemented as a continuous process.

Numbered embodiment 74. A protein composition comprising modified BLG, said protein composition is obtainable by the method according to one or more of the preceding numbered embodiments, the protein composition preferably having one or more of:
a protein content of at least 30% w/w relative to total solids,
at most 10 micromol free thiol groups per g protein,
a tryptophan content of at least 0.7% w/w relative to total protein,
a methionine content of at least 0.3% w/w relative to total protein,
a kynurenine content of at most 0.2 micrograms/mg protein,
preferably, a fat content of at most 3% w/w relative to total solids,
preferably, a content of protein-bound sulfur in the range of 100-600 micromol/g protein,
preferably, a content of protein-bound cysteine residues that form disulfide bonds in the range of 150-400 micromol/g protein.

Numbered embodiment 74.1. The modified whey protein composition according to numbered embodiment 74 having a protein content of at least 30% w/w relative to total solids.

Numbered embodiment 74.2. The modified whey protein composition according to numbered embodiment 74 or 74.1 having at most 10 micromol free thiol groups per g protein.

Numbered embodiment 74.3. The modified whey protein composition according to any one of numbered embodiment 74-74.2 having a tryptophan content of at least 0.7% w/w relative to total protein.

Numbered embodiment 74.4. The modified whey protein composition according to any one of numbered embodiment 74-74.3 having a methionine content of at least 0.3% w/w relative to total protein.

Numbered embodiment 74.5. The modified whey protein composition according to any one of numbered embodiment 74-74.4 having a kynurenine content of at most 0.2 micrograms/mg protein.

Numbered embodiment 74.6. The modified whey protein composition according to any one of numbered embodiment 74-74.5 having a fat content of at most 3% w/w relative to total solids.

Numbered embodiment 74.7. The modified whey protein composition according to any one of numbered embodiment 74-74.6 having a content of protein-bound sulfur in the range of 100-600 micromol/g protein.

Numbered embodiment 74.8. The modified whey protein composition according to any one of numbered embodiment 74-74.7 having a content of protein-bound cysteine residues that form disulfide bonds in the range of 150-400 micromol/g protein.

Numbered embodiment 75. The modified whey protein composition according to any one of numbered embodiment 74-74.8 having an average molecular weight of the protein in the range of 18 kDa and 10000 kDa, more preferably between 50-8000 kDa, and most preferably 80-5000 kDa.

Numbered embodiment 76. The protein composition according to any one of numbered embodiment 74-74.8 having an average molecular weight of the protein in the range of 18 kDa and 500 kDa, more preferably between 18-100 kDa, and most preferably 18-40 kDa.

Numbered embodiment 77. A process for producing a heat-treated, preferably heat-sterilized, beverage, the process comprising the following steps:
1) mixing the protein composition according to one or more of numbered embodiments 74-76 with one or more further beverage ingredients to obtain a liquid mixture having a pH of 5.5-8.5, and
2) filling the liquid mixture into suitable containers,
the process furthermore comprising at least one heat-treatment step wherein the liquid mixture is heat-treated, and preferably heat-sterilized, prior to filling and/or after filling.

Numbered embodiment 78. The process according to numbered embodiment 77 wherein the liquid mixture comprises the protein composition in an amount sufficient to contribute with at least 0.5% w/w protein.

Numbered embodiment 79. A heat-treated, preferably heat-sterilized, beverage having a pH of 5.5-8.5, obtainable by the process according to numbered embodiment 77 or 78.

Numbered embodiment 80. A heat-treated, preferably heat-sterilized, beverage having a pH of 5.5-8.5, and more preferably 6.5-7.5, the beverage comprising the protein composition according to one or more of numbered embodiments 74-76 in an amount sufficient to contribute with at least 0.5% w/w protein, and preferably having a content of H₂S 7 days after production of at most 5 micromol/L, more preferably at most 3 micromol/L, even more preferably at most 1.0 micromol/L, and most preferably at most 0.7 micromol/L.

Numbered embodiment 81. A food ingredient comprising:
the solids of the protein composition according to one or more of numbered embodiments 74-76, and
one or more further ingredient(s), preferably selected from:
   a dairy ingredient, preferably a non-oxidized dairy ingredient,
   a plant-based ingredient,
   a non-dairy carbohydrate source,
   a flavouring agent, and/or
   a sweetener, preferably comprising a carbohydrate sweetener, a polyol, a high intensity sweetener, or a combination thereof.

Numbered embodiment 82. Use of a protein composition comprising modified BLG, preferably the protein composition according to one or more of numbered embodiments 74-76, as a food ingredient, preferably for:
improving the odour, and/or
reducing the level of unpleasant odour similar to the odour of rotten eggs, and/or
reducing the development of H2S during production, and/or
reducing the content of H2S in the headspace of the container,
   of heat-sterilized, beverages having a pH in the range of 5.5-8.5, preferably having a whey protein content of at least 3% w/w, and preferably heat-sterilized using indirect heat-treatment.

The present invention has been described above with reference to specific embodiments. However, other embodiments than the above described are equally possible within the scope of the invention. The different features and steps of various embodiments and aspects of the invention may be combined in other ways than those described herein unless it is stated otherwise.

### EXAMPLES

### Analysis 1: Determination of the Theoretical Amount of Quinone Provided During the Method

The “theoretical amount of quinone provided to the protein solution during the method” is a measure of the mole content of quinones that is formed if all PCA (incl. PCA that have been converted to quinones) present in the protein solution of the method was oxidized under the same conditions and under the same oxidizing conditions used in the method but without the presence of proteins or other sources of free thiols or amines.

For example, if the method of the invention is based on oxidation of the PCA (to provide a source comprising one or more oxidized PCA) prior to mixing with the source comprising BLG, then the content of quinones in the source comprising one or more oxidized PCA is equal to the theoretical quinone content.

The content of quinones is determined according to Analysis 2.

### Analysis 2: Quantification of the Content of Quinones

The content of quinones of a liquid sample is quantified as described below. The quantification is based on the measuring reactive oxygen species generated from reduction of quinones by NaBH₄ with generated reactive oxygen species converting the colorimetric reagent 2-(4-iodophenyl)-3-(4-nitrophenyl)-5-phenyl-2H-tetrazolium chloride (INT) into a formazan dye.

### Stock Solutions:

NaH₂PO₄ buffer: The NaH₂PO₄ buffer is an aqueous solution of 0.1 M sodium dihydrogenphosphate adjusted to pH 11.85 using NaOH.

INT: the INT stock solution is freshly prepared as a solution of 400 micromolar INT in an aqueous solution of NaH₂PO₄ buffer.

NaBH₄: the NaBH₄ stock solution is freshly prepared as a solution of 300 millimolar NaBH₄ in an aqueous solution of NaH₂PO₄ buffer.

### Quinone Reference:

The quinone reference solution is based on 2 mM 4-methyl benzoquinone (4MBQ) and is prepared by electrochemical oxidation of 4-methylcatechol (4MC) as described by Li et al. (Li, Y., Jongberg, S., Andersen, M. L., Davies, M. J., & Lund, M. N. (2016). Quinone-induced protein modifications: Kinetic preference for reaction of 1, 2-benzoquinones with thiol groups in proteins. Free Radical Biology and Medicine, 97, 148-157):

A solution of 2 mM 4MC is prepared in phosphate buffer solution (0.2 M, pH 4.5) and deoxygenated by purging with nitrogen for 10 min. Cyclic voltammograms of the 4MC solution are obtained by using a voltammetry analyzer CV-50W (BAS Co., Ltd.) with a glassy carbon working electrode (3 mm diameter, BAS Co., Ltd.), a platinum coil counter electrode (5 mm in diameter and 5 cm in length), and an Ag/AgCl (KCl, c=3 M) reference electrode (Metrohm, Switzerland). The bulk electrolysis is performed at an initial potential of 460 mV versus Ag/AgCl under nitrogen by using the same CV-50W potentiostat, and the initial concentration of 4MC solution is 2 mM. The working electrode is a reticulated vitreous carbon tube with a diameter of 3.5 cm and length of 4.5 cm (BAS Co., Ltd.).

The quinone reference solution is used within 30 minutes after preparation.

### Calibration

A calibration curve is prepared using working solutions of the quinone reference solution in the concentration range of 0.001-4 micromolar by diluting the reference quinone solution with the NaH₂PO₄ buffer.

The calibration curve is obtained by plotting the absorbance versus the concentration of the reference quinone.

### Measurement of Quinone in the Sample

10 microliter of the liquid sample to be analysed are diluted and mixed with 490 microliter of the NaH₂PO₄ buffer.

50 microliter diluted sample are mixed with 100 microliter of INT stock in a well of a 96-well microplate, followed by addition of 50 microliter of NaBH₄-stock. The microplate is transferred to a microplate reader and shaken for 30 s. Subsequently, the microplate is allowed to incubate for 2 min, after which the absorbance of the well is read at 510 nm. The collected data are expressed as the mean of triplicate measurement using the quinone reference calibration curve.

Mixing, incubation and read-out are performed at room temperature (RT).

If the absorbance read-out is above the linear range of the analysis, a new sample is taken, subjected to appropriate dilution, and measured as described above.

### Calculation

The quinone content of the liquid sample is calculated by comparing the results from the measurement with the calibration curve and converting the quinone content to the desired unit. If the liquid sample was diluted prior to the measurement the quinone content is compensated for the dilution.

### Example 1: Elimination of Free Thiols in Whey Proteins by Use of Oxidized Phenolic Compounds

The purpose of this experiment was to confirm the inventors' initial findings and to demonstrate how the off-flavour development during heat-treatment of pH-neutral whey protein-rich beverages can be reduced and even avoided by reacting the whey protein, and particularly BLG, with oxidized phenolic compounds.

### Principle of the Reaction

The inventors have learned that dissolved dioxygen can oxidize PCA, such as EGCG, to quinones which again can react with the free thiol group of BLG if the free thiol group is properly exposed. The inventors have furthermore found that a combination of a well-aerated reaction mixture (containing dissolved dioxygen) and a sufficient headspace of atmospheric air (from which extra dioxygen can diffuse into the reaction mixture) can be used as a model system for oxidation of PCA and subsequent reaction between oxidized PCA and BLG.

### Materials and Methods

### Materials

A BLG-rich whey protein isolate powder (WPI-A) was prepared according to WO 2018/115520 A1. The characteristics of the powder are described in Table 1.

TABLE 1
Composition of WPI-A

| | WPI-A |
|---|---|
| Protein/dry matter | 97 |
| BLG, % of total protein | 99.5 |
| Na,% of total solids (TS) | 0.697 |
| K, % of TS | <0.025 |
| Mg, % of TS | <0.003 |
| Ca, % of TS | <0.025 |
| P, % of TS | <0.025 |
| pH of 10% solution | 6.9 |
| Lactose, % | <0.1 |
| Fat, % | <0.15 |
| Water | Approx. 4% |

4-Methylcatechol (4MC), epigallocatechine gallate (EGCG), bovine serum albumine (BSA) and trifluoroacetic acid (TFA) were purchased from Thermo Scientific, Thermo Scientific, Merck Life Science and Merck. All reagents were of analytical grade or of highest possible purity. Distilled water (MQ water) was obtained through a Milli-Q purification device (Millipore, Bedford, MA).

The 2 ml HPLC vials were 2 mL 32×11.6 mm injection vials (part no ML33003VU) from Mikrolab, Denmark.

### Measurement of Dissolved Dioxyqen

An O₂ microsensor (Unisense) was used to evaluate consumption of dissolved oxygen in PCA samples to evaluate oxygen consumption in samples.

Measurements were conducted according to the Unisense oxygen sensor user manual (March 2020 revision). The O₂ microsensor was calibrated using vigorously stirred water sample and water bubbled with N₂ for the concentration of oxygen in oxygen saturated water at RT and 0 micromol/L, respectively.

### Reaction Between Protein and PCA

Three 100 mL solutions each containing 4% w/w protein based on WPI-A powder were prepared by mixing powder with MQ water and subsequently allowing the mixture to hydrate under gentle stirring for 1 h at about 20 degrees C. after which the inventors observed no remaining powder particles and solution becomes transparent.

The solutions were adjusted to pH 7, 8 and 9, respectively, using minimum amount of 1 M NaOH. As described in Table 1, the WPI-A sample contains a very high level of BLG, and the inventors confirmed that the target concentration was reached within 5% error by measuring absorbance of the solution at 278 nm, using the specific extinction coefficient 0.96 L/g/cm⁻¹.

32 mM stock solutions of 4MC (MW 124.13 g/mol) or EGCG (MW 458.372 g/mol) were prepared in MQ water.

Protein solutions (pH 7, 8 or 9), PCA (4MC or EGCG) and water were mixed to a final protein concentration of 3% w/w (1.6 mM) and 2:1 (3.2 mM) or 5:1 (8 mM) PPA:BLG mol:mol to produce WPI-A4 to WPI-A15 solutions as shown in Table 2.

Samples were incubated for 1 h at 50 degrees C. in closed 2 mL HPLC vials with approximately 40% liquid and approximately 60% headspace (atmospheric air) by volume. The inventors estimated that the combined amount of O₂ present in the liquid and headspace was sufficient to oxidize substantially all PCA in the reaction mixtures to the quinone form.

TABLE 2
pH and PCA content/type of samples.

| | | | Stoichiometry |
|---|---|---|---|
| Sample | | | [PCA]: |
| no. | PH | PCA | [BLG] mol:mol |
| WPI-A1 | 7.0 | — | — |
| WPI-A2 | 8.0 | — | — |
| WPI-A3 | 9.0 | — | — |
| WPI-A4 | 7.0 | 4MC | 2:1 |
| WPI-A5 | 8.0 | 4MC | 2:1 |
| WPI-A6 | 9.0 | 4MC | 2:1 |
| WPI-A7 | 7.0 | 4MC | 5:1 |
| WPI-A8 | 8.0 | 4MC | 5:1 |
| WPI-A9 | 9.0 | 4MC | 5:1 |
| WPI-A10 | 7.0 | EGCG | 2:1 |
| WPI-A11 | 8.0 | EGCG | 2:1 |
| WPI-A12 | 9.0 | EGCG | 2:1 |
| WPI-A13 | 7.0 | EGCG | 5:1 |
| WPI-A14 | 8.0 | EGCG | 5:1 |
| WPI-A15 | 9.0 | EGCG | 5:1 |

### Determination of Free and Total Thiol Groups and of Total Protein

The content of free and total thiol groups in whey protein samples was quantified using the methods described by Kurz et al. (2020) using equipment identical to that used by the authors. The free thiols (SH) content in samples is typically reported in micromoles per gram of protein with the protein content determined by the total protein method described below.

Kurz, F., Hengst, C., & Kulozik, U. (2020). RP-HPLC method for simultaneous quantification of free and total thiol groups in native and heat aggregated whey proteins. MethodsX, 101112.

### Determination of Total Protein Content

The total protein content (true protein) of a sample was determined by:
1) Determining the total nitrogen of the sample following ISO 8968-1/2|IDF 020-1/2—Milk—Determination of nitrogen content—Part 1/2: Determination of nitrogen content using the Kjeldahl method.
2) Determining the non-protein nitrogen of the sample following ISO 8968-4|IDF 020-4—Milk—Determination of nitrogen content—Part 4: Determination of non-protein-nitrogen content.
3) Calculating the total amount protein as (m_{total nitrogen}−m_{non-protein-nitrogen})*6.38.

### Gel Permeation Chromatography (GPC) Analysis of the Molecular Weight of Whey Protein Species

The molecular weight of protein species in whey protein samples was analyzed by size exclusion chromatography using a SEC-MALS-IV-RI HPLC system essentially consisting of Thermo ISO.3100SD pump, WPS-3000TSL autosampler and Refractomax 521 refractive index detector. The system was further equipped with a Wyatt miniDawn TREOS II light scattering detector and a Wyatt Viscostar online viscometer.

All samples were diluted to 1% protein in eluent (10 mM phosphate, 30 mM NaCl pH 7.0) and samples (1 mL) were centrifuged at 15.000 g for 15 min to remove large protein aggregates. Injection volume: 10 microliter sample/supernatant. Sample was separated in the eluent at 0.75 mL/min using 1× Bio-SEC-5 guard+2×300 Å BioSEC-5.

Data analysis: Weight-average molecular weight (MW) and number-average molecular weight (Mn) was determined using the Astra software (v7.3.2.19) by analysis of refractive index and light scattering signals before the void volume, i.e. both monomer, oligomer and larger aggregate species. BSA was used as a standard to verify proper calibration and showed a molecular weight of 64.4 kDa (98% of theoretical) for the monomer peak.

The sample recovery was calculated from the total integral of eluting protein species relative to the protein content in samples prior to GPC sample preparation, where the centrifugation step can remove very large protein species.

With the exception of sample WPI-A3 (showing 42.6% recovery presumably due to excessive aggregation) all samples showed the surprisingly high mass recovery of >80% and most samples even 90-100%, suggesting that the vast majority of protein species are included in the analysis.

### LC-MS Analysis of the Protein Masses of the Protein-PCA Samples

The protein-PCA samples were diluted 30 times with MQ water to a concentration of 0.1% protein. The solution was filtered using a 0.22 micron PVDF filter into a HPLC vial (1.5 ml Short Thread Vial, 32×11.6 mm, clear glass (ML33117) with 0.1 ml Micro-Insert, 31×6 mm, clear glass (ML33119)). 10 microliter of the solution was injected into an HPLC where the protein was separated through an Avantor™ Ace™ ultracore BIO 300A C4 HPLC column

Mobile phase A: H₂O with 0.1% TFA (v/v)

Mobile phase B: Acetonitrile with 0.08% TFA (v/v)

TABLE 3
HPLC gradient

| Time | Mobile phase | Mobile phase |
|---|---|---|
| [min.] | A [%] | B [%] |
| 0.0 | 70 | 30 |
| 1.0 | 70 | 30 |
| 5.0 | 62 | 38 |
| 15.0 | 58 | 42 |
| 18.0 | 56 | 44 |
| 18.1 | 30 | 70 |
| 21.0 | 30 | 70 |
| 21.1 | 70 | 30 |
| 27.0 | 70 | 30 |

The proteins were detected using a UV_{214 nm} detector and a Thermo scientific Q-Exactive plus with Orbitrap MS in positive polarity, a scan range of 1000-3500 m/z, a resolution of 140.000, and a temperature of 500 degrees C.

The UV_{214 nm} data was analyzed using the FreeStyle software from Thermo Scientific. The UV_{214 nm} chromatograms were integrated using the Genesis algorithm with a cut-off peak size of 0.1% of the highest peak, minimum peak signal-to-noise ratio of 2, and valley detection enabled. The injection peaks at the beginning and the end of the chromatogram, which were also seen in a blank injection, were removed from the integrated peaks.

The high-resolution mass spectrometry data was used to identify the protein masses of the peaks in the chromatograms. The total ion chromatogram was integrated using the Genesis algorithm with the same conditions as for the UV peak integration. The mass-to-charge data was then extracted from each of the peaks and deconvoluted using the Xtract deconvolution feature with H⁺ as the adduct ion, a charge range of 5-50 and a minimum number of detected charges of 3.

### UHT Treatment

1.0 mL of sample were transferred to 2 mL HPLC vials and crimp-sealed using aluminium lids (Mikrolab ML 33032) and an electronic crimper (Thermo Scientific CRMA60180-ECRH11KI).

The sealed vials (at room temperature) were transferred to an aluminium heating block of a Mikrolab supertherm system (Control unit ML 306228 and heating unit ML3062409, Mikrolab A/S, Denmark) with holes drilled by the manufacturer to match the dimensions of the 2 mL GC vials. The block was preheated to 160 degrees C., and the samples were kept in the block for 160 seconds. The temperature reached 100 degrees C. in about 40 seconds, about 120 degrees C. in 65 seconds and reaches 140 C after 100 seconds of incubation and 150 degrees C. after 160 seconds. After incubation in the heating block, the samples were transferred to an ice-water bath to rapidly quench reactions leading to development of unpleasant odour. H₂S was measured directly within sealed vials according to section “Quantification of H₂S using a H₂S sensor.”

Quantification of H₂S using a H₂S Sensor

The level of H₂S was measured by a microsensor (SULF-NPLR, needle type, Unisense A/S, Denmark), which is connected to a single channel amplifier (Monometter-9514, Unisense A/S, Denmark). The obtained H₂S signal is shown as milli volt which can be used as indicator of H₂S levels in the sample, and logged in the software “LOGGER” provided by Unisense A/S. The microsensor was calibrated using an H₂S calibration kit supplied by the manufacturer (Calkit-H₂S, Unisense A/S, Denmark). The highest concentration of H₂S in the calibration kit was further diluted 10 times, according to section 7 in the manual (version November 2020, Unisense A/S). The concentration of the H₂S can be converted automatically by the software in the unit of micromolar.

To measure samples from UHT, samples were equilibrated for 30 minutes at 20 degrees C. and the sensor needle was pierced through the silicon sealing and into the liquid phase of the sample. Duplicates were carried out for each sample.

### Results

### Effect of the Reaction Between Protein and PCA on Free Thiol (SH) of the Protein

The free thiol content in samples WPI-A1 to WPI-A15 was measured as described above in section “Determination of free and total thiol groups and of total protein.” The results are displayed in Table 4.

A free thiol content of 45-46.3 micromol SH/g protein was measured in sample WPI-A1 to WPI-A3 after incubation at 50 degrees C. for 1 hour in the absence of added PCA.

Surprisingly, WPI-A4 incubated with 2:1 4MC:BLG at pH 7.0 showed a reduction (21.3%) in free thiol content relative to WPI-A1 (no PCA) within the 1 h incubation period. Even larger reductions in free thiol content were observed at pH 8 (78.9%) and 9 (89.8%) in WPI-A5 and WPI-A6, respectively.

Increasing the 4MC dosage to 5:1 4MC:BLG in sample WPI-A7 to WPI-A9 showed a similar pattern with free thiol reductions of 90 and 96% in sample WPI-A8 and WPI-A9, respectively, relative to samples without added 4MC.

The inventors further investigated the ability of EGCG, which is abundant in green tea extracts, to reduce the free thiol of whey protein compositions.

Samples WPI-A10 to WPI-A12 were incubated with 2:1 EGCG:BLG molar ratio. Significant reductions of 95% and 100% were found in samples WPI-A11 and WPI-A12 relative to samples without added EGCG (WPI-A2 and WPI-A3, respectively).

Increasing the dosage of EGCG to 5:1 EGCG:BLG resulted in 99.6-100% reduction in free thiol content relative WPI-A2 and WPI-A3.

### Effect of the Reaction Between Protein and PCA on the Molecular Weight of Protein Species

The molecular weight of protein species in samples WPI-A1 to WPI-A3 without added PCA and WPI-A4 to WPI-A15 samples incubated with PCA at 50 degrees C. for 1 h was analyzed by GPC as described above.

Table 4 shows the weight-average molecular weight of samples and weight-average molecular weight estimates from 26.5 to 278.3 kDa.

The largest weight-average MW was observed in WPI-A3 with 278.3 kDa and a recovery of 42.6%. The inventors expect that even larger aggregates removed in sample preparation account for the remaining ~58% of protein.

As shown in Table 4, the inventors surprisingly found that the addition of PCA to WPI samples consistently resulted in smaller MW estimates compared to the WPI sample with matching pH but without PCA added. This suggests that modification with added PCA reduces aggregation during incubation by blocking of thiol-disulfide exchange reactions.

Closer inspection of chromatograms and analysis of the molecular weight of individual peaks suggests that the fraction of proteins eluting when analyzing samples WPI-A1 to WPI-A15 predominantly follows the order of monomer>dimer>trimer>tetramer species>higher order aggregates.

Because the bulk amount of protein was found to elute as monomer or dimer species in GPC analysis, the inventors found it suitable to employ HPLC analysis with UV_{214 nm} and MS detection on intact proteins to evaluate the covalent association of PPAs to WPI-A (see section “LC-MS analysis of the protein masses of the protein-PCA samples”).

The inventors were able to successfully determine that the dominant forms of the BLG protein in the samples with BLG at pH 8 (WPI-A5 and WPI-A8) and pH 9 (WPI-A6 and WPI-A9) with 4MC added were modified versions of BLG with an increased mass of 122 Da to both BLG A and BLG B isoforms, corresponding to the mass of the quinone form of 4MC.

Furthermore, the inventors observed modified variants of BLG with an increased mass of 456 Da in samples with 2:1 EGCG:BLG (WPI-A11 and WPI-A12) and 5:1 EGCG:BLG (WPI-A14 and WPI-A15), corresponding to the mass of the quinone of EGCG, in samples containing EGCG at pH8 and pH9.

### Visual Inspection of the Samples

WPI-A1 to WPI-A3 samples did not show any colour changes during heat treatment and remained completely clear. A clear colour change is observed developing during heat treatment in samples with PCA, with a brownish colour for WPI-A4 to WPI-A9 and a faint brown/yellow colour for WPI-A10 to WPI-A15. The colour intensity variation among the samples dependent on both pH and PCA:BLG stoichiometry as shown in Table 4. Furthermore, at alkaline pH and in the presence of amines (Tris-buffer and folded BLG before heat treatment), 4MC is observed to develop a red/pink colour. Notably, red/pink colour development was not observed in the samples.

TABLE 4
Residual free thiol, molecular weight, visual appearance after incubation with oxidized
PCA. Percentages shown denote the level of free thiol reduction relative to the
WPI sample at the same pH without added PCA (samples WPI-A1 to WPI-A3).

| | | | | Free thiols, | | |
|---|---|---|---|---|---|---|
| | | | | micromol | Weight-aver- | |
| | | | Stoichio-metry | SH/g protein | age molecular | |
| Sample | | | [PCA]:[BLG] | (% reduction | weight, kDa | Colour |
| ID | pH | PCA | mol:mol | with PCA) | (by GPC) | (visual) |
| WPI-A1 | 7.0 | — | — | 45.0 | 39.2 | Colourless |
| WPI-A2 | 8.0 | — | — | 45.5 | 42.5 | Colourless |
| WPI-A3 | 9.0 | — | — | 46.4 | 278.3 | Colourless |
| WPI-A4 | 7.0 | 4MC | 2:1 | 35.4 (21%) | 26.5 | Brown |
| | | | | | | +++ |
| WPI-A5 | 8.0 | 4MC | 2:1 | 9.5 (79%) | 37.5 | Brown |
| | | | | | | ++ |
| WPI-A6 | 9.0 | 4MC | 2:1 | 4.6 (90%) | 42.7 | Brown |
| | | | | | | + |
| WPI-A7 | 7.0 | 4MC | 5:1 | 28.4 (37%) | 31.4 | Brown |
| | | | | | | ++++ |
| WPI-A8 | 8.0 | 4MC | 5:1 | 1.7 (96%) | 40.1 | Brown |
| | | | | | | +++ |
| WPI-A9 | 9.0 | 4MC | 5:1 | 4.7 (90%) | 37.2 | Brown |
| | | | | | | +++++ |
| WPI-A10 | 7.0 | EGCG | 2:1 | 33.6 (25%) | 32.2 | Faint |
| | | | | | | brown/ |
| | | | | | | yellow |
| WPI-A11 | 8.0 | EGCG | 2:1 | 2.5 (95%) | 27.3 | Faint |
| | | | | | | brown/ |
| | | | | | | yellow |
| WPI-A12 | 9.0 | EGCG | 2:1 | 0 (100%) | 32.1 | Slightly |
| | | | | | | more yellow |
| WPI-A13 | 7.0 | EGCG | 5:1 | 26.9 (40%) | 31.6 | As |
| | | | | | | WPI-A22 |
| WPI-A14 | 8.0 | EGCG | 5:1 | 0.16 (99.6%) | 29.9 | Almost |
| | | | | | | colourless |
| WPI-A15 | 9.0 | EGCG | 5:1 | 0 (100%) | 35.0 | Almost |
| | | | | | | colouress |

### Effect of the Reaction Between Protein and PCA on H₂S Development

Sample WPI-A5 (2:1 4MC:BLG) and reference sample WPI-A2 were pH adjusted to pH 7 and subjected to UHT treatment (see section “UHT treatment”). The generated H₂S (off-flavour) was subsequently quantified as described in section “Quantification of H₂S using a H₂S sensor.” The reference (WPI-A2) had generated 7.9 micromolar H₂S, whereas only 1.5 micromolar H₂S was present in the 4MC treated sample (WPI-A5), showing a reduction in off-flavour for the 4MC treated sample.

### Conclusion

The inventors have demonstrated that oxidation of PCA at pH 7 to 9 is sufficient to reduce and even eliminate the amount of free thiols of BLG in a whey protein solution. The inventors have observed that even lower contents of free thiol can be obtained at pH 7.0 by increasing the temperature and/or pressure.

Reacting BLG and other whey proteins with oxidized PCA thus constitutes a feasible route for reducing the content of free thiol groups of the protein. The inventors have previously observed that protein having a high content of free thiol groups gives rise to an unpleasant odour when used in whey protein solutions or beverages that are subjected to e.g. UHT treatments. The present invention therefore provides a new and surprising approach for reducing the development of unpleasant odours during production and consumption of heat-treated, pH neutral, whey protein-rich beverages.

### Example 2: Dose-Response of 4MC Subjected to Electrochemical Oxidation

The purpose of this experiment was to document the possibility of using electrochemical oxidation to generate quinones from polyphenol solutions and use said generated quinones to reduce the amount of free thiols in whey proteins.

### Materials and Methods

### Protein Source:

WPI-A as described in Example 1 was used as protein source.

### Determination of Quinone Content:

To determine the concentration of quinone generated, a L-Glutathione (GSH) assay was used. The principle of this assay is that quinone will react with the free thiol in GSH and the residual amount of unreacted GSH is then determined with RP-HPLC. The quinone content thus corresponds to the loss of GSH. Inventors found that this GSH assay was a good alternative to Analysis 2.

A 6 mM GSH solution was prepared in 5 mM phosphate buffer pH 4.5. GSH and quinone solutions were mixed 1:1 in an Eppendorf tube for reaction and the mixture was separated and quantified at 214 nm relative to a standard curve of known GSH concentration by the same method used for free thiol determination in example 1. The amount of quinone is then determined as the concentration of lost GSH as compared to a sample of GSH mixed 1:1 with electrolysis buffer (no quinone).

### Electrochemical Oxidation of Quinones:

30 mL 5 mM phosphate buffer pH 4.5, 200 mM NaCl solution was deoxygenated by purging with nitrogen gas in the electrolysis cell (Redox.me 50 mL two-compartment cell; Redoxme AB, Sweden. The whey protein-quinone samples and reference whey protein sample were incubated at 80° C. for 30 minutes and cooled.

Removal of Excess Quinone Solution after Reaction with Protein:

Non-reacted/excess 4MC and 4MBQ after the reaction with protein were partially removed from the samples by an ultrafiltration process: 1 mL reacted sample was transferred to a 10 kDa cutoff Amicon ultra spin filter and centrifuged for 20 min at 3400×g in a swinging bucket rotor allowing collection of 100 μL retentate. The retentate was recovered by diluting retentate to 1% protein using 5 mM phosphate buffer pH 7 and transfer of each samples to Eppendorf vials for further analysis. The inventors observed no sign of protein losses using this filtration routine.

### UHT Treatments:

UHT treatments and measurement of resulting H₂S development in samples was quantified by use of a H₂S sensor as described in Example 1.

The content of free thiol groups was measured in the recovered retentates and after UHT treatment as described in Example 1.

### Results:

Cyclic voltammetry showed a typical “duck” shape with peak oxidation potential for 4MC at around +550 mV which was subsequently used to generate quinones during bulk electrolysis. A yield of 27.7% 4MBQ was determined by the GSH quinone assay yielding 4MBQ:BLG ratios of from 0.07:1 (SampleWPI-A16) to 0.56:1 (Sample WPI-A19) respectively as given in Table 5. After reaction was ended by cooling and excess reagent was removed the free thiol content was analyzed as shown for WPI-A16 to WPI-A19 in table 5. Surprisingly even low amounts of the added quinone solution was sufficient to significantly reduce the amount of free thiols in WPI-A16 and an even greater reduction in free thiol was observed after UHT treatment. The inventors thus found that electrochemical oxidation of 4MC solution to form quinones and mixing same with BLG under conditions allowing reactions with the free thiol can reduce the amount of free thiols to levels which give rise less than 1 μmol/L H2S was detected by the H2S sensor. This compared to the highly undesired level of 16.9 μmol/L measured after UHT treatment of the non-treated WPI-A20 control. The inventors surprisingly further observed that WPI-A16 was essentially colorless.

The larger amounts of added quinone solution in WPI-A17 to WPI-A19 decreased the residual thiol content of samples to an even lower amount and UHT treatment decreased the free thiol content even further. As a consequence, H2S levels below 1 μmol/L was measured in these samples after UHT treatment. The results of Example 2 are summarized in Table 5.

TABLE 5
Results obtained in Example 2.

| | | | Free | Free | |
|---|---|---|---|---|---|
| | | | thiol | thiol | |
| | Original | | in reten- | after | H2S, |
| Sample | 4MC: | 4MBQ: | tate, | UHT, | μmol/ |
| ID | BLG | BLG | μmol/g | μmol/g | L |
| WPI-A16 | 0.25:1 | 0.07:1 | 25.4 | 7.8 | 0.76 |
| WPI-A17 | 0.5:1 | 0.19:1 | 14.7 | 2.4 | 0.31 |
| WPI-A18 | 1:1 | 0.28:1 | 4.1 | 2.3 | 0.17 |
| WPI-A19 | 2:1 | 0.56:1 | 1.9 | 0.6 | 0.09 |
| WPI-A20 | 0:1 | 0:1 | 45.2 | 40.7 | 16.9 |

### Conclusions

The inventors documented that generation of quinones by electrochemical oxidation and subsequent mixing with whey protein makes it feasible to reduce the contents of free thiol groups even when using surprisingly low stoichiometries between quinones and BLG.

The reduced content of free thiols resulted in a low level of generated H2S during UHT treatment of the modified protein samples. The inventors note that the tested samples only contained 1% BLG. Higher contents of whey protein would lead to significantly higher levels of H₂S.

The reaction product resulting from the sample with the lowest amount of added quinone (WPI-A16) was found to be essentially colorless whereas the reacted samples based on higher stoichiometries were slightly coloured. If protein sources for colourless beverages should be prepared, the inventors therefore find it preferable to use as low contents of polyphenol and quinone amount as possible to achieve the required level free thiol reduction.

The inventors further observed that it can be beneficial to conduct a second heat treatment, e.g. in the form of a UHT treatment to further reduce the free thiol content in whey protein solutions during the incubation step. The inventors also point out that UHT treated whey protein solutions like the ones of Table 5 (or protein concentrates thereof) can be converted to protein powders by e.g. spray-drying or other drying methods.

### Example 3: Impact of Controlling Oxygen Exposure

The purpose of these experiments was to document how O₂-based oxidation of polyphenols to quinones can be controlled by controlling the accessible headspace volumes.

### Methods and Materials

### Protein Source:

These experiments utilized WPI-A from example 1.

### Sample Preparation:

The following samples were prepared using WPI-A as protein source.

Samples WPI-A21, -A22: A stock solution containing 3% protein from WPI-A, 3.2 mM 4MC and having a pH of 8.0 was prepared (having molar ratio between 4MC and BLG of 2:1). Sample WPI-A21 was prepared by transfer of 1 mL of the stock solution to a 2 mL HPLC vial (see the UHT treatment of Example 1) which were crimp-sealed to reduce further exposure to atmospheric air. The sample WPI-A21 thus consisted of 1 mL aqueous sample and 1 mL headspace of atmospheric air including dioxygen.

Sample WPI-A22 was prepared by transferring 2 mL of the stock solution to a 2 mL HPLC vial and subsequently sealing the vial as described above. Sample WPI-A22 therefore did not contain a headspace.

Sample WPI-A23: Sample WPI-A23 was prepared by transfer of 1 mL of a stock solution similar to the one described above but without added 4MC to a 2 mL HPLC vial which was crimp-sealed to reduce further exposure to atmospheric air and thus contained equal volumes of aqueous phase and headspace of atmospheric air.

WPI-A21 to WPI-A23 were incubated at 20° C. for 2 days to allow sufficient time for generation of quinones by O₂-based oxidation and transfer of O₂ from headspace where applicable.

The free thiols content of all samples was quantified as described in example 1.

### Results

TABLE 6
Results obtained in Example 3.

| | | | | | Free |
|---|---|---|---|---|---|
| Sample | Pro- | Incu- | | 4MC: | thiol, |
| ID | tein | bation | Headspace^{*)} | BLG | μmol/g |
| WPI-A21 | 3% | 20° C., | 50% | 2:1 | 1.7 |
| | | 2 days | | | |
| WPI-A22 | 3% | 20° C., | 0% | 2:1 | 19.1 |
| | | 2 days | | | |
| WPI-A23 | 3% | 20° C., | 50% | 0:1 | 45 |
| | | 2 days | | | |

^{*)} Headspace relative to total vial volume

The inventors have previously found that in a slightly alkaline pH is useful for exposing free thiols in BLG and the inventors have furthermore found that incubation of equal volumes of sample and head-space of atmospheric air for a prolonged time of 2 days constitutes an effective mean to block free thiols in the sample as evidenced by the decrease of free thiols in sample WPI-A21 of 1.7 μmol/g protein compared to 45 μmol/g protein WPI-A23 incubated in absence of PCA. Surprisingly, both WPI-A21 and WPI-A22 were essentially colorless suggestion despite of the 3% WPI-A concentration employed. The inventors speculate that lack of color development is closely linked to restrictions in O₂ allowing sufficient generation of quinone to react with free thiols in WPI-A21 yet not exceeding O₂ levels resulting in undesired color development.

Additionally, the inventors found that limiting access to atmospheric air by filling vials completely and thereby leave no head-space resulted in a more modest decrease in free thiol content in sample WPI-A22 to 19.1 μmol SH/g protein corresponding to a reduction of free thiols of ~57% relative to WPI-A23. The inventors speculate that only O₂ dispersed in sample prior to experiment allows for some quinone formation and thereby reaction with free thiols but the absence of headspace that may act as a reservoir for O₂ results in less efficient blocking of free thiols compared to WPI-A21. The inventors therefore found that it is beneficial to increase the exposure to O₂ by increasing access to O₂ exemplified by the larger (yet still restricted) headspace of atmospheric air of sample WPI-A22 in which the content of free thiol groups was reduced to 1.7 μmol SH/g protein.

Beyond controlling exposure to O₂ via accessible head-space, the inventors suggest that other means to control access to O₂ can be utilized, e.g. pressurization or atmospheres with more concentrated O₂.

Further, while samples of the present investigation was not stirred it may be beneficial to stir samples to increase the rate of O₂ transfer to aqueous phase.

### Conclusions

These results demonstrate that restricted access to O₂ reduces the potential for O₂-based generation of quinones that can react with free thiols.

The inventors thus conclude that controlling and securing access to sufficient O₂ is advantageous when O₂ is the soles oxidizing agent used quinones generation.

The inventors find that the higher protein concentration used during processing of the present example is advantageous for industrial implementation and that protein solution having even higher protein concentrations could be processed according to the present invention.

The inventors further conclude that restricting O₂ access constitutes an attractive approach to reducing undesired color development in products.

### Example 4: Direct Heating Under UHT-Like Conditions

The purpose of these experiments was to document the possibility of using PCA to form quinones and enable reaction with free thiols using UHT-like heating conditions.

### Materials and Methods

These experiments used WPI-A from example 1.

### Sample Preparation:

A stock solution containing 3% protein from WPI-A, 3.2 mM 4MC and having a pH of 8.0 was prepared (having molar ratio between 4MC and BLG of 2:1).

Sample WPI-A24 was prepared by transferring 1 mL of the stock solution to a 2 mL HPLC vial and subsequently sealing the vial as described in Example 3. Sample WPI-A24 thus contained equal volumes of aqueous phase and headspace of atmospheric air.

Sample WPI-A25: Sample WPI-A25 was prepared by transfer of 1 mL of a stock solution similar to the one described above but without added 4MC to a 2 mL HPLC vial which was crimp-sealed and therefore also contained equal volumes of aqueous phase and headspace of atmospheric air.

The HPLC vials containing sample WPI-A24 and WPI-A25 samples were incubated for 160 seconds in an aluminium block preheated to 160° C. and immediately cooled in an ice-water bath. Free thiols were then quantified as described in example 1.

### Results

TABLE 6
Results obtained in Example 4.

| | | | | | Free |
|---|---|---|---|---|---|
| Sample | Pro- | Incu- | | 4MC: | thiol, |
| ID | tein | bation | Headspace^{*)} | BLG | μmol/g |
| WPI-A24 | 3% | 160°C/160 | 50% | 2:1 | 0 |
| | | seconds | | | |
| WPI-A25 | 3% | 160°C/160 | 50% | 0:1 | 46 |
| | | seconds | | | |

^{*)} Headspace relative to total vial volume

The results presented in Table 6 demonstrate that heating of sample WPI-A25 in absence of quinones is not sufficient to eliminate free thiols provided by WPI-A. In contrast, heating of sample WPI-A24 which contains 2:1 4MC:BLG molar ratio and equal volumes of head-space and aqueous phase was observed to fully eliminate free thiols.

The inventors further observed by visual inspection that WPI-A24 was essentially colorless suggesting that the O₂ availability was sufficient to produce enough quinones to reduce the amount of free thiols but avoided the formation of coloured products.

### Conclusions

The inventors found that the combination of pH 8 and UHT-like treatment to facilitate sufficient exposure of free thiols to quinones derived from 4MC with equal volumes of liquid sample and a head-space of atmospheric air allows for efficient blocking of free thiols at high temperature for a short time.

The inventors further note that the accessible head-space volume was equal that of sample WPI-A21 in example 3 to secure sufficient access to O₂ to facilitate O₂-based quinone generation which in combination with the high temperature allows for efficient blocking with free thiols in sample WPI-A24 compared to WPI-A25.

### Example 5: In-Situ Generation and Reaction of Quinones with Free Thiols

The purpose of these experiments was to document the possibility of using PCA to form quinones in presence of whey protein in a ‘one-step’ modification procedure considered advantageous for industrial processing.

### Methods

Cyclic voltametry was conducted to evaluate the extent and potential of electrochemical reactions as described in Example 2. First, 30 mL 1% WPI-A solution in 25 mM phosphate buffer pH 7.5, 200 mM was preheated to 60° C. within an aluminium block preheated to 60° C. The heating block was designed specifically to fit and fully span both sides and bottom of the electrochemistry cell of Example 2 and was placed in the heating unit employed for UHT treatments as described in Example 1. Cyclic voltammetry was conducted using the electrodes described in Example 2 applying −0.2 to +0.8V. Next, 30 mL 1.09 mM 4MC in 25 mM phosphate buffer H 7.5, 200 mM NaCl and finally 30 mL 1% WPI-A solution in 25 mM phosphate buffer pH 7.5, 200 mM NaCl with 1.09 mM 4MC (2:1 4MC:BLG) was analyzed.

Based on cyclic voltammetry measurements, a 30 mL 1% WPI-A solution in 25 mM phosphate buffer pH 7.5, 200 mM was preheated to 60° C. within an aluminium block preheated to 60° C. The heating block was designed specifically to fit and fully span both sides and bottom of the electrochemistry cell of example 2 and was placed in the heating unit employed for UHT treatments as described in example 1.

A 2 mL WPI-A26 sample was withdrawn prior to addition of 4MC and bulk electrolysis to constitute zero reaction time as shown in Table 7.

250 μl 33 mM 4MC dissolved in nitrogen degassed MQ water and kept in a syringe to minimize exposure to oxygen was injected into the cell via HPLC connection tubes immediately after taking sample WPI-A26 to bring 4MC:BLG ratio to 0.5. A potential of 0.45V was applied to the cell and timing was started.

2 mL WPI-A27 sample was taken after 5 min bulk electrolysis followed by addition of 250 μl 33 mM 4MC was added bringing the combined addition of 4MC to a 1.2:1 4MC:BLG molar ratio. 2 mL WPI-A28 sample was taken after 10 minutes of bulk electrolysis and the experiment was stopped.

All samples were cooled to 4° C. immediately after sampling.

Non-reacted reagent was removed by use of spin-filters as described in example 2. Free thiols of the spin filter retentates of sample WPI-A26 to WPI-A28 was determined as described in example 1.

The retentates of WPI-A26, WPI-A27, and WPI-A28 were subjected to UHT-like thermal treatment and H2S was determined as described in Example 1.

In a separate experiment, sample WPI-A29 (30 mL 5% WPI-A in 100 mM NaCl, pH 8.5 prepared from nitrogen degassed MQ) was equilibrated at 60° C. in the electrochemistry cell as described for sample WPI-A26. 4MC was added to a final concentration of 5.4 mM (2:1 4MC:BLG) and bulk electrolysis was conducted at 0.45V for 20 minutes. The reaction was quenched by dilution to a protein content of 1% using cold 25 mM phosphate pH 7.0 buffer. Non-reacted reagent was removed by use of spin-filters as described in Example 2. Free thiols of the spin filter retentate of sample WPI-A29 was determined as described in Example 1.

### Results

TABLE 7
Results obtained in Example 5.

| | | | | Free | |
|---|---|---|---|---|---|
| | | Total | | thiols, | |
| | | 4MC: | Reaction | μmol | |
| Sample | | BLG | time, | SH/g | H2S, |
| ID | Protein | added | min | protein | μmol/L |
| WPI-A26 | 1% | 0:1 | 0 | 49 | 19 |
| WPI-A27 | 1% | 0.5:1 | 5 | 23 | Not |
| | | | | | determined |
| WPI-A28 | 1% | 1.2:1 | 10 | 5.9 | 0.2 |
| WPI-A29 | 5% | 2:1 | 20 | 5.7 | Not |
| | | | | | determined |

Cyclic voltammetry conducted on a 1% WPI-A solution pH 7.5 at 60° C. without added 4MC did not show signs of oxidation or reduction peaks otherwise characteristic of the “duck shaped”. In contrast, the inventors observed that the applied voltage range did result in duck shaped voltammograms when analyzing quinone alone and quinone in combination with protein. The applied voltage is thus considered to mediate the oxidation of 4MC to 4MBQ. An oxidation potential of 0.45V was identified and used the trials of Example 5.

As shown in Table 7, the inventors initially observed a high level of free thiols and correspondingly high generation of H2S upon UHT treatment when analyzing WPI-A26 prior to addition of 4MC.

After 5 min of bulk electrolysis with 4MC added to 0.5:1 4MC:BLG the thiol content of sample WPI-A27 had decreased to 23 μmol SH/g protein. The inventors noted that the reaction mixture remained essentially colorless.

After 10 min of bulk electrolysis with a combined addition to 1.2:1 4MC:BLG the thiol content of sample WPI-A28 had further decreased to 6 μmol SH/g protein. Additionally, less than 1 μmol/L H2S was measured in the UHT treated sample as a result of the decrease in free thiol content. The inventors furthermore observed only a faint color development in the retentate of WPI-A28. The inventors have previously observed that bulk electrolysis of 4MC at neutral pH in absence of whey protein may result in significant color development. In the present investigations, the inventors observed a significant decrease in color development and observed no sign of undesired side-reactions during bulk electrolysis.

Sample WPI-A29 was produced with a higher protein content (5%) than the other samples and with 5.4 mM 4MC (2:1 4MC:BLG molar ratio). After bulk electrolysis for 20 minutes, a large reduction in free thiol content to 5.7 μmol SH/g protein was observed relative to WPI-A treated in absence of added 4MC (see e.g. WPI-A26). The inventors noted that approximately 9 mg/L (~280 μM) oxygen soluble is water at 20° C. and the amount decreases with increasing temperature. Thus, while the inventors employed nitrogen-flushed sources of buffer for sample preparation to reduce potential oxidation by dissolved O₂, even saturation with oxygen in the starting solution would correspond to only ~5% of polyphenol concentration present (5.4 mM). Together, these experiments clearly demonstrate both the feasibility of using direct electrochemical generation of quinones to facilitate their reaction with free thiols and the potential of using electrochemical oxidation of polyphenols and the reaction with free thiols to reduce undesired H2S generation upon UHT treatments.

### Conclusions

The electrochemical oxidation of quinones in presence of whey proteins at slightly alkaline pH and elevated temperature constitutes an advantageous approach for reducing the content of free thiol groups of whey protein solutions.

The inventors have found that by using a relatively low dosage of polyphenol and by using direct oxidation of the polyphenol in the presence of the whey protein the concentration of quinones can be kept low during the reaction step of the present method. The inventors have found this approach to reduce or even avoid, colour-development caused by quinone side-reactions. This approach is particularly advantageous for the preparation of protein sources that should be used in colourless food applications, e.g. colourless, high protein beverages.

1. A method of producing a protein composition comprising modified beta-lactoglobulin (BLG), the method comprising the steps of:
a) providing:
a source comprising one or more phenolic compounds that contain at least two hydroxyl groups bound directly to the same aromatic ring (PCA), and
a source comprising BLG,
b) optionally, subjecting a portion of the source comprising one or more PCA to a type of oxidation capable of converting a PCA to a quinone (referred to as PCA-type oxidation) thereby providing a source comprising one or more oxidized PCA,
c) combining a portion of the source comprising one or more PCA and/or a portion of the source comprising one or more oxidized PCA with a source comprising BLG and optionally with further ingredients to provide a protein solution, said protein solution having:
a pH in the range of 6.5-9.5, and
a BLG content of at least 0.2% w/w,
a mole ratio between:
the original amount of PCA used for preparing the protein solution, and
the content of BLG of the protein solution,
of at least 0.1:1,
d) incubating the protein solution within a temperature range and for a duration sufficient to reduce the amount of free thiol groups of the protein solution to at most 10 micromol/g protein, with the proviso that if the method does not contain step b), step d) also involves application of a type of oxidation capable of converting a PCA to a quinone.

2. The method according to claim 1, wherein the PCA-type oxidation applied during step b) and/or step d) is sufficient to create a mole ratio between:
the theoretical amount of quinone provided to the protein solution during the method determined according to Analysis 1, and
the amount of BLG of the protein solution
of at least 0.1:1.

3. The method according to claim 1 or 2 wherein the PCA comprises:
a flavonoid, preferably a flavanol or a flavanol ester, e.g. catechin, epicatechin, gallocatechin, epigallocatechin, catechin 3-gallate, epicatechin 3-gallate, gallo-catechin 3-gallate, and epigallocatechin 3-gallate (EGCG), and/or
a stilbenoid, preferably resveratrol.

4. The method according to any one of the preceding claims wherein the PCA:
comprises caffeic acid, gallic acid, chlorogenic acid, catechol, 4-methyl catechol, catechin, epicatechin, gallocatechin, epigallocatechin, catechin 3-gallate, epicatechin 3-gallate, gallocatechin 3-gallate, epigallocatechin 3-gallate (EGCG), resveratrol, carnosic acid, carnosol, naringenin, or a mixture thereof, and/or
has a molecular weight in the range of 120-1000 g/mol, more preferably 250-700 g/mol, even more preferably 300-650 g/mol, and most preferably 350-600 g/mol, and/or
has a water solubility of at least 8 mM at 25 degrees C., more preferably at least 12 mM, and most preferably at least 16 mM.

5. The method according to any one of the preceding claims wherein the source comprising one or more PCA:
is selected from the group consisting of a polyphenol extract from a herb, a polyphenol extract from a spice, polyphenol extract from a fruit, polyphenol extract from a berry, and mixtures thereof, and/or
is selected from the group consisting of a polyphenol extract of tea, more preferably a polyphenol extract of green tea; a polyphenol extract of coffee; polyphenol extract of cocoa; a polyphenol extract of grapes; a polyphenol extract of rosemary; a polyphenol extract of lemon balm; a polyphenol extract of black currant; a single PCA-isolate, and mixtures thereof.

6. The method according to any one of the preceding claims wherein the source comprising BLG comprises, or even consists of, a whey protein concentrate, a whey protein isolate, a milk serum protein concentration, a milk serum protein isolate, a BLG isolate, or a combination thereof.

7. The method according to any one of the preceding claims comprising step b) of subjecting a portion of the source comprising one or more PCA to a type of oxidation capable of converting a PCA to a quinone thereby providing a source comprising one or more oxidized PCA.

8. The method according to any one of the preceding claims wherein the protein solution has one or more of, and more preferably all of:
a pH in the range of 6.7-9.5, even more preferably 7.1-9.0, even more preferably 7.3-8.7, and most preferably 7.4-8.5,
a BLG content of at least 0.5% w/w, more preferably at least 1% w/w, even more preferably at least 3% w/w, and most preferably at least 6% w/w,
a BLG content of 0.5-30% w/w, more preferably 1-20% w/w, even more preferably 3-16% w/w, and most preferably 5-12% w/w,
a BLG content of at least 30% w/w relative to total protein, more preferably at least 40% w/w relative to total protein, even more preferably at least 45% w/w relative to total protein, and most preferably at least 50% w/w relative to total protein, and
a BLG content of 30-99% w/w relative to total protein, more preferably 40-95% w/w relative to total protein, even more preferably 45-90% w/w relative to total protein, and most preferably 50-80% w/w relative to total protein.

9. The method according to any one of the preceding claims wherein the protein solution of step c) has a mole ratio between:
the original amount of PCA used for preparing the protein solution, and
the content of BLG of the protein solution
of at least 1:1.

10. The method according to any one of claims 1-8 wherein the protein solution of step c) has a mole ratio between:
the original amount of PCA used for preparing the protein solution, and
the content of BLG of the protein solution
of 0.1:1-100:1, more preferably 0.1:1-50:1, even more preferably 0.1:1-20:1, and most preferably 0.1:1-10:1.

11. The method according to any one of claims 1-8 wherein the protein solution has a mole ratio between:
the original amount of PCA used for preparing the protein solution, and
the content of BLG of the protein solution
of 0.1:1-5:1, more preferably 0.1:1-4:1, even more preferably 0.2:1-3:1, and most preferably 0.3:1-2:1.

12. The method according to any one of claims 1-8 wherein the protein solution has a mole ratio between:
the original amount of PCA used for preparing the protein solution, and
the content of BLG of the protein solution
of 1:1-100:1, more preferably 1:1-50:1, even more preferably 1:1-20:1, and most preferably 1:1-10:1.

13. The method according to any one of claims 1-12 wherein the oxidation applied during step b) and/or step d) is sufficient to create a mole ratio between:
the theoretical amount of quinone provided to the protein solution during the method determined according to Analysis 1, and
the content of BLG of the protein solution
of 0.1:1-100:1, more preferably 0.1:1-50:1, even more preferably 0.2:1-15:1, and most preferably 0.2:1-5:1.

14. The method according to any one of claims 1-12 wherein the oxidation applied during step b) and/or step d) is sufficient to create a mole ratio between:
the theoretical amount of quinone provided to the protein solution during the method determined according to Analysis 1, and
the content of BLG of the protein solution
of 0.1:1-5:1, more preferably 0.1:1-4:1, even more preferably 0.2:1-3:1, and most preferably 0.2:1-2:1.

15. The method according to any one of claims 1-12 wherein the oxidation applied during step b) and/or step d) is sufficient to create a mole ratio between:
the theoretical amount of quinone provided to the protein solution during the method determined according to Analysis 1, and
the content of BLG of the protein solution
of at least 1:1.

16. The method according to any one of claims 1-12 wherein the oxidation applied during step b) and/or step d) is sufficient to create a mole ratio between:
the theoretical amount of quinone provided to the protein solution during the method determined according to Analysis 1, and
the content of BLG of the protein solution
of 1:1-100:1, more preferably 1:1-50:1, even more preferably 1:1-15:1, and most preferably 1.5:1-5:1.

17. The method according to any one of the preceding claims:
wherein the method comprises step b) and the portion of the source comprising one or more oxidized PCA obtained from step b) is used for the preparation of the protein solution of step c), and
wherein the PCA-type oxidation is performed by electrochemical oxidization.

18. The method according to any one of the preceding claims wherein the PCA-type oxidation applied during step b) is sufficient to create a mole ratio between:
the quinone content of the portion of the source comprising one or more oxidized PCA that is used in the protein solution, and
the amount of BLG of the protein solution
of at least 0.1:1, more preferably at least 0.2:1, even more preferably at least 0.2:1, and most preferably at least 0.2:1.

19. The method according to any one of claims 1-16 wherein the PCA-type oxidation applied during step b) is sufficient to create a mole ratio between:
the quinone content of the portion of the source comprising one or more oxidized PCA that is used in the protein solution, and
the amount of BLG of the protein solution
of at least 1.1:1, more preferably at least 1.3:1, even more preferably at least 1.5:1, and most preferably at least 2:1.

20. The method according to any one of the preceding claims furthermore comprising step e) of drying a liquid feed comprising at least the protein derived from the incubated protein solution of step d), preferably wherein the liquid feed for drying comprises or even consists of the protein solution obtained from step d) or a protein concentrate thereof.

21. A protein composition comprising modified BLG and having at most 10 micromol free thiol groups per g protein, said protein composition is obtainable by the method according to one or more of the preceding claims, the protein composition preferably having one or more of:
a protein content of at least 30% w/w relative to total solids,
a tryptophan content of at least 0.7% w/w relative to total protein,
a methionine content of at least 0.3% w/w relative to total protein,
a kynurenine content of at most 0.2 micrograms/mg protein,
preferably, a fat content of at most 3% w/w relative to total solids,
preferably, a content of protein-bound sulfur in the range of 100-600 micromol/g protein,
preferably, a content of protein-bound cysteine residues that form disulfide bonds in the range of 150-400 micromol/g protein.

22. The modified whey protein composition according to claim 21 having a protein content of at least 30% w/w relative to total solids.

23. The modified whey protein composition according to claim 21 or 22 having a tryptophan content of at least 0.7% w/w relative to total protein.

24. The modified whey protein composition according to any one of claims 21-23 having a methionine content of at least 0.3% w/w relative to total protein.

25. The modified whey protein composition according to any one of claims 21-24 having a kynurenine content of at most 0.2 micrograms/mg protein.

26. The modified whey protein composition according to any one of claims 21-25 having a fat content of at most 3% w/w relative to total solids.

27. The modified whey protein composition according to any one of claims 21-26 having a content of protein-bound sulfur in the range of 100-600 micromol/g protein.

28. The modified whey protein composition according to any one of claims 21-26 having a content of protein-bound cysteine residues that form disulfide bonds in the range of 150-400 micromol/g protein.

29. The modified whey protein composition according to any one of claims 21-27 having an average molecular weight of the protein in the range of 18 kDa and 10000 kDa, more preferably between 50-8000 kDa, and most preferably 80-5000 kDa.

30. The protein composition according to any one of claims 21-27 having an average molecular weight of the protein in the range of 18 kDa and 500 kDa, more preferably between 18-100 kDa, and most preferably 18-40 kDa.

31. A process for producing a heat-treated, preferably heat-sterilized, beverage, the process comprising the following steps:
1) mixing the protein composition according to one or more of claims 21-30 with one or more further beverage ingredients to obtain a liquid mixture having a pH of 5.5-8.5, and
2) filling the liquid mixture into suitable containers,
the process furthermore comprising at least one heat-treatment step wherein the liquid mixture is heat-treated, and preferably heat-sterilized, prior to filling and/or after filling,
preferably wherein the liquid mixture comprises the protein composition in an amount sufficient to contribute with at least 0.5% w/w protein.

32. The process for producing a heat-treated, preferably heat-sterilized, beverage according to claim 31 wherein the liquid mixture contains, prior to the heat-sterilisation, at most 60 micromol free thiol groups/100 g liquid mixture, more preferably at most 40 micromol free thiol groups/100 g liquid mixture, even more preferably at most 30 micromol free thiol groups/100 g liquid mixture, and most preferably at most 30 micromol free thiol groups/100 g liquid mixture.

33. The process for producing a heat-treated, preferably heat-sterilized, beverage according to claim 31 wherein the liquid mixture contains, prior to the heat-sterilisation, at most 20 micromol free thiol groups/100 g liquid mixture, more preferably at most 15 micromol free thiol groups/100 g liquid mixture, even more preferably at most 10 micromol free thiol groups/100 g liquid mixture, and most preferably at most 5 micromol free thiol groups/100 g liquid mixture.

34. The process for producing a heat-treated, preferably heat-sterilized, beverage according to any one of claims 31-33 wherein the liquid mixture comprises a total amount of protein in the range of 0.5-15% w/w relative to the weight of the liquid mixture, more preferably 1-10% w/w relative to the weight of the liquid mixture, even more preferably 2-9% w/w relative to the weight of the liquid mixture, and most preferably 3-8% w/w relative to the weight of the liquid mixture.

35. The process for producing a heat-treated, preferably heat-sterilized, beverage according to any one of claims 31-34 wherein the liquid mixture comprises a total amount of protein in the range of 4-15% w/w relative to the weight of the liquid mixture, more preferably 5-14% w/w relative to the weight of the liquid mixture, even more preferably 6-13% w/w relative to the weight of the liquid mixture, and most preferably 8-12% w/w relative to the weight of the liquid mixture.

36. The process for producing a heat-treated, preferably heat-sterilized, beverage according to any one of claims 31-35 wherein the protein composition according to one of more of claims 21-30 contributes with at least 30% w/w of the total protein of the liquid mixture, more preferably at least 50% w/w of the total protein, even more preferably at least 70% w/w of the total protein, and most preferably at least 80% w/w of the total protein.

37. The process for producing a heat-treated, preferably heat-sterilized, beverage according to any one of claims 31-36 wherein the protein composition according to one of more of claims 21-30 contributes with at least 90% w/w of the total protein of the liquid mixture, more preferably at least 95% w/w of the total protein, even more preferably at least 99% w/w of the total protein, and most preferably 100% w/w of the total protein.

38. The process for producing a heat-treated, preferably heat-sterilized, beverage according to any one of claims 31-37 wherein the liquid mixture comprises total protein in an amount of at least 15% w/w relative to total solids, more preferably at least 20% w/w, and most preferably at least 25% w/w, and most preferably at least 30% w/w relative to total solids.

39. The process for producing a heat-treated, preferably heat-sterilized, beverage according to any one of claims 31-38 wherein the liquid mixture comprises total protein in an amount of at least 80% w/w relative to total solids, more preferably at least 90% w/w, even more preferably at least 92% w/w, and most preferably at least 94% w/w relative to total solids.

40. The process for producing a heat-treated, preferably heat-sterilized, beverage according to any one of claims 31-39 wherein the liquid mixture has a solids content of 0.5-50% w/w, more preferably 1-35% w/w, even more preferably 2-20% w/w, and most preferably 3-10% w/w.

41. The process for producing a heat-treated, preferably heat-sterilized, beverage according to any one of claims 31-40 wherein the part of the liquid mixture that is not made up of solids comprises water in an amount of at least 80% w/w, more preferably at least 90% w/w, even more preferably at least 95% w/w, and more preferably at least 99% w/w.

42. The process for producing a heat-treated, preferably heat-sterilized, beverage according to any one of claims 31-41 wherein the liquid mixture has a calorie content of at most 100 kcal/100 g, more preferably at most 80 kcal/100 g, even more preferred at most 70 kcal/100 g, and most preferably at most 60 kcal/100 g.

43. The process for producing a heat-treated, preferably heat-sterilized, beverage according to any one of claims 31-41 wherein the liquid mixture has a calorie content of more than 100 kcal/100 g, more preferably at least 120 kcal/100 g, even more preferred at least 140 kcal/100 g, and most preferably at least 150 kcal/100 g.

44. A heat-treated, preferably heat-sterilized, beverage having a pH of 5.5-8.5, obtainable by the process according to one or more of claims 30-43.
